(19) United States
(12) Patent Application Publication
(10) Pub. No.: US 2022/0080663 A1
(43) Pub. Date: Mar. 17, 2022

(54) HEIGHT ADJUSTMENT IN A METHOD OF THREE DIMENSIONAL PRINTING

(71) Applicant: CHROMATIC 3D MATERIALS INC., Golden Valley, MN (US)

(72) Inventors: Cora LEIBIG, Maple Grove, MN (US); Shihchuan KAO, New Brighton, MN (US); Garth BENSON, Burnsville, MN (US); Michael GARROD, Minnetrista, MN (US)

(21) Appl. No.: 17/535,526

(22) Filed: Nov. 24, 2021

Related U.S. Application Data
(63) Continuation-in-part of application No. 16/433,324, filed on Jun. 6, 2019, now Pat. No. 11,065,816.
Application No. 16/433,324 is a continuation of application No. PCT/US2017/064941, filed on Dec. 6, 2017.
Application No. PCT/US2017/064941 is a continuation-in-part of application No. 17/225,377, filed on Apr. 8, 2021.
Application No. 17/225,377 is a division of application No. 16/433,324, filed on Jun. 6, 2019, now Pat. No. 11,065,816.
Application No. 16/433,324 is a continuation-in-part of application No. PCT/US2021/044252, filed on Aug. 3, 2021.
Application No. PCT/US2021/044252 is a continuation-in-part of application No. PCT/US2021/036383, filed on Jun. 8, 2021.
Application No. PCT/US2021/036383 is a continuation-in-part of application No. PCT/US2021/033541, filed on May 21, 2021.
Application No. PCT/US2021/033541 is a continuation-in-part of application No. PCT/US2020/046388, filed on Aug. 14, 2020.
Application No. PCT/US2020/046388 is a continuation-in-part of application No. 17/613,920.
Application No. 17/613,920 is a continuation-in-part of application No. PCT/US2017/064941, filed on Dec. 6, 2017.
Application No. PCT/US2017/064941 is a continuation-in-part of application No. 16/749,671, filed on Jan. 22, 2020.
Application No. 16/749,671 is a continuation of application No. 16/256,657, filed on Jan. 24, 2019, now Pat. No. 10,639,842.
Application No. 16/256,657 is a continuation of application No. PCT/US2018/064323, filed on Dec. 6, 2018.
Application No. PCT/US2018/064323 is a continuation-in-part of application No. 16/749,671, filed on Jan. 22, 2020.
Application No. 16/749,671 is a continuation of application No. 16/256,657, filed on Jan. 24, 2019, now Pat. No. 10,639,842.
Application No. 16/256,657 is a continuation of application No. PCT/US2018/064323, filed on Dec. 6, 2018.
Application No. 16/749,671 is a continuation of application No. 16/256,657, filed on Jan. 24, 2019, now Pat. No. 10,639,842.
Application No. 16/256,657 is a continuation of application No. PCT/US18/64323, filed on Dec. 6, 2018.
Application No. 16/749,671 is a continuation of application No. 16/256,657, filed on Jan. 24, 2019, now Pat. No. 10,639,842.
Application No. 16/256,657 is a continuation of application No. PCT/US18/64323, filed on Dec. 6, 2018.
(60) Provisional application No. 63/118,229, filed on Nov. 25, 2020.
(60) Provisional application No. 62/524,214, filed on Jun. 23, 2017.
(60) Provisional application No. 62/430,919, filed on Dec. 6, 2016.
(60) Provisional application No. 63/060,342, filed on Aug. 3, 2020.
(60) Provisional application No. 63/036,115, filed on Jun. 8, 2020.
(60) Provisional application No. 63/028,174, filed on May 21, 2020.
(60) Provisional application No. 62/887,397, filed on Aug. 15, 2019.
(60) Provisional application No. 62/851,902, filed on May 23, 2019.
(60) Provisional application No. 62/524,214, filed on Jun. 23, 2017.
(60) Provisional application No. 62/595,400, filed on Dec. 6, 2017.
(60) Provisional application No. 62/595,400, filed on Dec. 6, 2017.
(60) Provisional application No. 62/595,400, filed on Dec. 6, 2017.
(60) Provisional application No. 62/595,400, filed on Dec. 6, 2017.

(51) Int. Cl. B29C 64/336; B33Y 10/00; B33Y 70/00; B33Y 80/00; B29C 64/118; B29C 67/24; B29C 64/321; B29C 64/106

(52) U.S. Cl. CPC B29C 64/336; B33Y 10/00; B33Y 70/00; B33Y 80/00; B29K 2075/00; B29C 67/246; B29C 64/321; B29C 64/106; B29C 64/118

(57) ABSTRACT

A three-dimensional (3D) object and a 3D object production process is disclosed comprising depositing the thermosetting resin along the deposition path during at least a portion of which the thermosetting resin is produced and deposited according to the one or more deposition parameters to form one or more layers of the thermosetting resin according to the predefined design; scanning at least a portion of the one or more of the deposited layers of the thermosetting resin to detect one or more perturbations present therein, which differ from the predefined design to form a perturbation profile; adjusting the one or more deposition parameters of one or more subsequent layers based the perturbation profile; and depositing the subsequent one or more layers of thermosetting resin according to the adjusted deposition parameters to form the 3D object according to the predefined design.

### RELATED APPLICATIONS

This application claims priority to U.S. Provisional application 63/118,229, filed Nov. 25, 2020; is a continuation-in-part of U.S. application Ser. No. 16/433,324 filed Jun. 6, 2019, now U.S. Pat. No. 11,065,816, which is a continuation of International application PCT/US2017/64941 filed Dec. 6, 2017, which claims priority to U.S. Provisional application 62/524,214 filed Jun. 23, 2017 and to U.S. Provisional application 62/430,919, filed Dec. 6, 2016; is a continuation-in-part of U.S. application Ser. No. 17/225,377 filed Apr. 8, 2021, which is a division of U.S. application Ser. No. 16/433,324 filed Jun. 6, 2019; is a continuation-in-part of International application PCT/US2021/044252 filed Aug. 3, 2021, which claims priority to U.S. Provisional application 63/060,342 filed Aug. 3, 2020; is a continuation-in-part of International application PCT/US2021/036383 filed Jun. 8, 2021, which claims priority to U.S. Provisional application 63/036,115 filed Jun. 8, 2020; is a continuation-in-part of International application PCT/US2021/033541 filed May 21, 2021, which claims priority to U.S. Provisional application 63/028,174 filed May 21, 2020; is a continuation-in-part of International application PCT/US2020/046338 filed Aug. 14, 2020, which claims priority to U.S. Provisional application 62/887,397 filed Aug. 15, 2019; is a continuation in part of U.S. application Ser. No. 17/613,920, filed Nov. 23, 2021, which is a continuation of International application PCT/US2020/034181, filed May 22, 2020, which in turn claims priority to U.S. Provisional application 62/851,902, filed May 23, 2019; is a continuation-in-part of International application PCT/US17/64941 filed Dec. 6, 2017, which claims priority to U.S. Provisional application 62/524,214; and is a continuation-in-part of U.S. application Ser. No. 16/256,657, filed Jan. 24, 2019, now U.S. Pat. No. 10,639,842, which is a National phase application of International application PCT/US2018/064323, filed Dec. 6, 2018, which claims priority to U.S. Provisional patent application 62/595,400, filed Dec. 6, 2017; and is a continuation-in-part of U.S. application Ser. No. 16/749,671, filed Jan. 22, 2020, which is a continuation of U.S. application Ser. No. 16/256,657, filed Jan. 24, 2019. The contents of each of which are fully incorporated by reference herein.

### FIELD

The present disclosure relates to 3D additive manufacturing methods and methods of 3D additive manufacturing using a scanner to detect a perturbation in a layer and adjusting the depositing of a subsequent layer based on a perturbation profile. The application also relates to a 3D object prepared by 3D additive manufacturing.

### BACKGROUND

Fused filament fabrication (FFF), also referred to as thermoplastic extrusion, plastic jet printing (PJP), fused filament method (FFM), or fusion deposition modeling, is an additive manufacturing process wherein a material is extruded in successive layers onto a platform to form a three-dimensional (3D) product. Typically, FFF uses a melted thermoplastic material that is extruded onto a platform. Three-dimensional printing (3D printing) sometimes uses support structures that are easily dissolved or removed from the part after printing.

Disadvantages of existing FFF technology using thermoplastics include single material property printing, limited print-direction strength, limited durability, and limited softness. Thermosetting resins have generally not been used in FFF because prior to cure, the monomers are low viscosity liquids, and upon deposition, the curing liquid flows or breaks into droplets, resulting in finished parts of low quality and undesirably low resolution. Attempts to print with thermosetting resins has required addition of fillers (such as inorganic powders or polymers) to induce thixotropic behavior in the resin before it is fully cured. These solutions adversely affect the final properties of the printed part. Other problems include poor resolution control in the printed part and frequent clogging of mixing systems.

An individual layer printed using 3D printing methods may sometimes have defects or perturbations which differ from the predefined or intended design of the 3D object. These defects or perturbations may become more prominent for parts having many layers, leading to poor resolution and inconsistent production.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

The present disclosure is directed to 3D printing processes and 3D printed objects. In embodiments, a three-dimensional (3D) object production process comprises the steps of: a) providing a thermoset printing apparatus comprising: a mixing chamber into which a plurality of components comprising a first reactive component and a second reactive component are directed and contacted to produce an extrudable thermosetting resin; an extrusion nozzle in fluid communication with the mixing chamber through which the thermosetting resin is extruded and deposited onto a substrate or at least a portion of another layer of the thermosetting resin; at least one actuator coupled to the extrusion nozzle configured to move the extrusion nozzle; a controller coupled to the thermoset printing apparatus configured to produce the thermosetting resin and direct the deposition of the thermosetting resin from the extrusion nozzle along a deposition path according to one or more deposition parameters to form the 3D object according to a predefined design; and a scanner coupled to the thermoset printing apparatus; b) depositing the thermosetting resin along the deposition path during at least a portion of which the thermosetting resin is deposited according to the one or more deposition parameters to form one or more layers of the thermosetting resin according to the predefined design; c) scanning at least a portion of the one or more layers of the thermosetting resin to detect one or more perturbations present therein, which differ from the predefined design to form a perturbation profile; d) adjusting the one or more deposition parameters of one or more subsequent layers based the perturbation profile; and e) depositing the subsequent one or more layers of thermosetting resin according to the adjusted deposition parameters to form the 3D object according to the predefined design.

In embodiments, an article comprises a three-dimensional (3D) object is produced according to processes disclosed herein.

It is to be understood that both the Summary and the Detailed Description are exemplary and explanatory only, and are not restrictive of the disclosure as claimed.

### BRIEF DESCRIPTION OF THE FIGURES

FIG. 1 depicts a 3D printed object where the tip height was too low;

FIG. 2 depicts a 3D printed object where the tip height was too high;

FIG. 3 depicts a flowchart showing an embodiment of an adaptive printing process;

FIG. 4 depicts an embodiment of a 3D printer;

FIG. 5 depicts scanning positions during printing of a 3D object;

FIG. 6A shows a scanned object according to an embodiment of this disclosure;

FIG. 6B shows a scanned object determined deposition path according to an embodiment of this disclosure;

FIG. 6C shows a corrected scanned object determined deposition path according to an embodiment of this disclosure;

FIG. 7A shows a scanned object according to an embodiment of this disclosure;

FIG. 7B shows a scanned layer of an object according to an embodiment of this disclosure;

FIG. 7C shows a scanned object determined deposition path according to an embodiment of this disclosure;

FIG. 8A shows a scanned object according to an embodiment of this disclosure;

FIG. 8B shows a scanned object deposition path according to an embodiment of this disclosure; and

FIG. 8C shows a scanned object predefined design deposition path according to an embodiment of this disclosure.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a physical range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

The following definitions are provided in order to aid those skilled in the art in understanding the detailed description.

The articles “a,” “an,” and “the” refer to one or more than one (i.e., to at least one) of the grammatical object of the article. By way of example, “an element” means one element, at least one element, or more than one element.

As used herein, the term “additive manufacturing” refers to extruded printing of thermosetting resin, also referred to herein as a thermosetting resin. Additive manufacturing may be used interchangeably with 3D printing.

As used herein, a thermosetting resin As used herein, the terms “thermoset,” “thermoset product,” and/or “thermoset material” are used interchangeably and refer to the reaction product of at least two chemicals which form a covalently bonded crosslinked or polymeric network. In contrast to thermoplastics, a thermoset product described herein undergoes an irreversible reaction wherein the material forms a non-flowable solid or flexible material, also referred to in the art as being “set” or “cured”.

As used herein, the term “thermosetting resin” and/or “thermosetting material” are used interchangeably, and refer to a flowable, fluid or extrudable mixture of reactive compounds which may have a degree of curing or crosslinking, yet are essentially fluid, having an indeterminate shape that will irreversibly cure to a degree wherein the mixture is no longer fluid, but instead forms a “thermoset material” of a defined shape and confirmation. Accordingly, a thermosetting resin, while it may comprise partially crosslinked or cured moieties, is characterized as being pumpable and will eventually become a non-pumpable more fully cured thermoset material having a particular shape. The thermosetting resins disclosed herein comprise at least two reactive components that form a covalently bonded crosslinked or polymeric network. However, it is to be understood that a thermoset or cured material may still comprise reactive sites or moieties, e.g., it may still have hydroxyl, amine, and/or isocyanate functionality that produce a measurable hydroxyl number, NH number, or NCO number upon titration or via other wet chemical or spectroscopic methods of determination. However, thermoset materials are crosslinked or cured to a point where they are no longer pumpable or they may no longer be extruded using a 3D printing apparatus.

As used herein, the term “extrusion percent” means the percent of material extruded in one layer compared to the 100% value generated by the slicer and the G-code, which may be represented by a predicted amount of material extruded for a layer. For example, if a layer was extruded using 105% of the predicted material, the subsequent layer could remedy this overextrusion by extruding 95% of the material extruded in previous layer.

As used herein, the terms “deposition path”, “layer translation path”, or just “path” are used interchangeably, and refer to the 2 or 3 dimensional path that is traversed by the printhead or extrusion nozzle forming at least a portion of a layer of the 3D printed object. It is to be understood that extrusion or deposition of the thermosetting resin does not necessarily occur throughout the deposition path, as the flow of thermosetting resin may be started and stopped at various points along the deposition path. Likewise, the conditions utilized to print the layer, e.g., the one or more deposition parameters, may vary at any point along the deposition path.

For purposes herein, the one or more deposition parameters utilized to form the 3D object refer to any of the parameters which will affect the printing and/or the 3D object printed by the process. Examples include the deposition path itself, a bead spacing used to deposit the thermosetting resin onto a substrate or at least a portion of another layer, a tip height, determined as a distance of the extrusion nozzle above the layer and/or substrate on which the thermosetting resin is deposited during at least a portion of the deposition path, an extrusion percent at which the thermosetting resin is extruded during at least a portion of the deposition path, which is a percentage of a total amount of the thermosetting resin predicted to be required during the portion of the deposition path according to the predefined design, a flow rate of the thermosetting resin through the extrusion nozzle during at least portion of the deposition path, a pumping pressure applied to the thermosetting resin within the extrusion nozzle during at least portion of the deposition path, which may be positive or negative to prevent flow of the thermosetting resin by overcoming the hysteresis and/or viscoelasticity of the material present in the extrusion nozzle and/or mixer, a translation speed of the extrusion nozzle along at least a portion of the deposition path, and the like. Other deposition parameters include those which affect the composition and thus, physical and/or rheological properties of the thermosetting resin. For example one or more deposition parameters may be the composition of the thermosetting resin being deposited, and/or may be adjusted by increasing an amount of one or more of the reactive components into the mixing chamber relative to another (e.g., decreasing at least one or increasing at least one, or both), directing another component, or increasing an amount of at least one other component directed into the mixing chamber relative to another, the very composition of one or more of the reactive components being directed into the mixing chamber may be changed with one replacing another, the cure rate of the thermosetting resin being deposited may be adjusted by methods known in the art, such as by adding an accelerant, a cure retarder, and/or by controlling a temperature, the viscosity of the thermosetting resin being deposited may also be adjusted by changes in the composition or by addition of various improvers or reducers. Other rheological properties may be adjusted such as the viscoelasticity of the thermosetting resin being deposited by modifications of composition and the like.

For purposes herein G-code refers generically to any of the used computer numerical control (CNC) programming languages used in computer-aided manufacturing to control the 3D printer and other automated tools. It does not refer to any specific variant of such code and is not intended to limit the scope of this disclosure.

The G-code instructions are provided to and may be provided by the printer controller coupled to the 3D printer, are utilized to move the at least one actuator coupled to the extrusion nozzle and/or control any number of other components coupled to the thermoset printing apparatus configured to produce the thermosetting resin and/or direct the deposition of the thermosetting resin from the extrusion nozzle along a deposition path according to one or more deposition parameters to form the 3D object according to a predefined design.

The predefined design refers to the intended end product e.g., the digital image or representation of a particular layer required to produce the 3D object, or the entire 3D object. Perturbations refer to differences between what is actually produced, and the intended product.

As used herein, the term “perturbation profile” refers to the summation of or an analysis of the perturbations scanned, sensed, or detected on a layer.

For purposes herein, the thermosetting resin is deposited onto either a substrate, or at least a portion of another layer of thermosetting resin. This term may be used interchangeably with extrusion of the thermosetting resin through the extrusion nozzle or print tip.

As used herein, viscosity refers to Brookfield viscosity determined using the appropriate spindle assembly at temperature of 25° C. unless indicated otherwise.

As used in the specification and claims, “near” is inclusive of “at.”

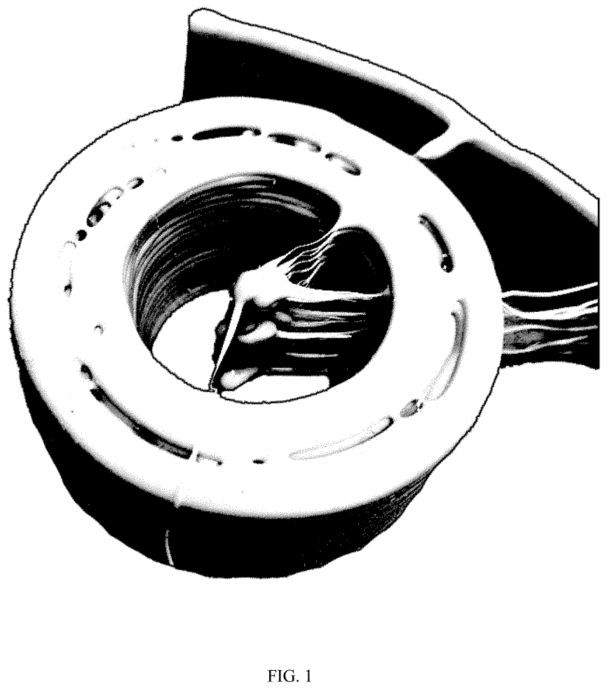

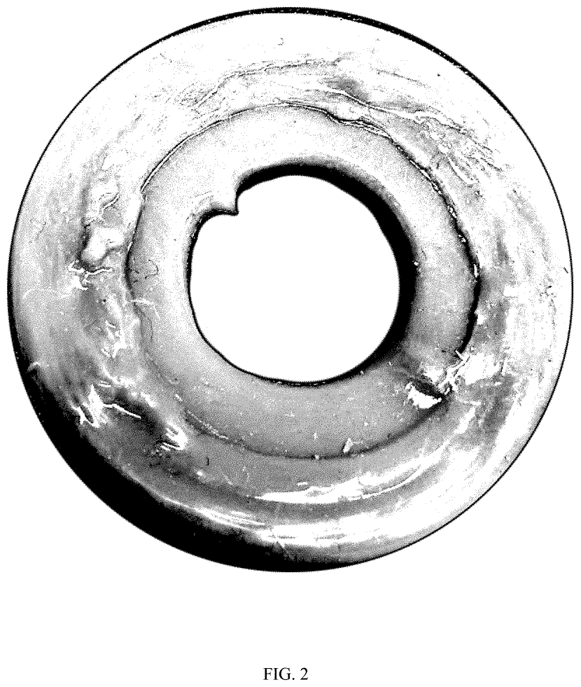

In 3D multicomponent reactive printing (such as in 3D printing where a plurality of two or more liquids that may react upon mixing, are mixed just before the deposition process, and wherein the material, upon deposition, may be a flowable semisolid, e.g., having the viscosity of a flowable gel, there may be perturbations, dimensional defects, or variations or deviations from the predicted height. As a result, the actual height may be different from the predicted height. As a result, this may create printing inconsistencies and poor resolution of a finished 3D part. For tall parts and parts with many layers, these perturbations may create even more noticeable problems. FIG. 1 depicts a 3D printed object where the tip height was too low; the tip was dragging resin from previous layers as it was printing a subsequent layer, creating bumps and valleys in the part. FIG. 2 depicts a 3D printed object where the tip height was too high; the gaps became wider over successive layers.

Applicant has surprisingly discovered that these problems may maybe overcome by using a scanner in a 3D printing process to determine whether the object being printed is developing a dimensional defect, and then making adjustments to the printing process to correct that dimensional defect. The perturbation may maybe that the part is taller or shorter than the anticipated height, which is detected by the scanner, and the print bed may be adjusted higher or lower to accommodate the difference. The defect may be that the part is uneven, and material is deposited to fill in or flatten the layer, or the flow in subsequent layers may be adjusted to make subsequent layers flat.

When a perturbation or defect is found in the nth layer, the printing instructions for the nth+1 layer may be adjusted to remedy the perturbation. In embodiments, a three-dimensional (3D) object production process comprises providing a thermoset printing apparatus comprising a mixing chamber which is in fluid communication with the extrusion nozzle, e.g., the printing tip. In embodiments, the mixing chamber and the extrusion nozzle are one piece with a static mixer terminating into a frustoconical tip, which may have a particular diameter or which may be adjustable. A plurality of components comprising a first reactive component and a second reactive component are directed into the mixing chamber e.g., pumped, and contacted e.g., mixed, to begin a chemical reaction in which the components form i.e., to produce, an extrudable thermosetting resin.

For purposes herein, it is understood that the extrusion nozzle is in fluid communication with an outlet of the mixing chamber, and the extrusion nozzle comprises an orifice through which the thermosetting resin is extruded and deposited onto a substrate, or at least a portion of another layer of the thermosetting resin. The printing apparatus further includes at least one actuator, e.g., a servo, drive motor, and/or the like, coupled to the extrusion nozzle e.g., a printing gantry, configured to move the extrusion nozzle in the x, y, and/or z plane relative to the object being printed along a deposition path. The printing apparatus further includes one or more controllers coupled to the thermoset printing apparatus which are configured to produce the thermosetting resin e.g., by controlling the selection of the components directed into the mixing chamber, the amount of each component both relative to another and in total, a temperature of various aspects of the process e.g., of the mixing chamber, and directs the deposition of the thermosetting resin from the extrusion nozzle along a deposition path according to one or more deposition parameters to form the 3D object according to a predefined design. The predefined design being intended design of the object, e.g., the “digital representation” of the design. The printing apparatus further includes one or more scanners coupled to the thermoset printing apparatus.

For purposes herein, the term “scanner” is used generically to represent a measuring device capable of obtaining information related to physical dimensions, compositions, morphology, rheological properties, and/or other attributes of the deposited layers, which is useful to determine if the layer or layers are being deposited or printed according to the predefined design intended by the process. The scanner is not limited to optical devices, but may use any portion of the electromagnetic spectrum, and/or any means suitable to obtain the needed information.

The process of producing or manufacturing the 3D objects includes utilizing the 3D printer apparatus and associated components to deposit the thermosetting resin along the deposition path. During at least a portion of the deposition path, the thermosetting resin is deposited according to the one or more deposition parameters to form one or more layers of the thermosetting resin according to the predefined design. The process further includes utilizing the “scanner” to “scan” or otherwise obtain the information discussed above over at least a portion of the one or more layers of the thermosetting resin to detect one or more perturbations present therein. These perturbations are areas which differ in some meaningful way from the predefined design. These data are then recorded, combined, manipulated, and/or analyzed to form a perturbation profile of the object being printed at that particular stage in the process. The perturbation profile is then used e.g., by the controller and/or a computer control system, to adjust one or more of the deposition parameters utilized by the controller to produce the layers of the 3D object, and to incorporate these adjustments into the deposition of one or more subsequent layers of the process, based the perturbation profile. The process then deposits the subsequent one or more layers of thermosetting resin according to the adjusted deposition parameters to form the 3D object according to the predefined design.

It is to be understood that the perturbation profile may be obtained at any point and/or at any time, and/or continuously and/or semi-continuously during the process, and there is no limit to the number of times or manner in which the combined steps of:
i) depositing the thermosetting resin along the deposition path during at least a portion of which the thermosetting resin is produced and deposited according to the one or more deposition parameters to form one or more layers of the thermosetting resin according to the predefined design;
ii) scanning at least a portion of the one or more of the deposited layers of the thermosetting resin to detect one or more perturbations present therein, which differ from the predefined design to form a perturbation profile;
iii) adjusting the one or more deposition parameters of one or more subsequent layers based the perturbation profile; and
iv) depositing the subsequent one or more layers of thermosetting resin according to the adjusted deposition parameters to form the 3D object according to the predefined design,
   may be conducted during the production of forming of the 3D object. For example, a first layer may be deposited, the layer “scanned”, the perturbation profile determined, one or more deposition parameters adjusted, and a second layer deposited using these adjusted deposition parameters. In embodiments, this deposited material produced by depositing this second layer now becomes the first layer, and these steps of the process repeat until the 3D object is formed according to the predefined design.

These steps together may form a single process step, an iterative process step, may be conducted on a continuous or semicontinuous basis, or any combination thereof. Likewise, different “scanners” may be employed and/or different methods of determining the perturbation profile may be used in any combination, at any point of the process of forming the 3D object.

In embodiments of the process, the scanner comprises an optical scanner, a laser scanner, a profile sensor, a point laser sensor, a confocal displacement sensor, an X-ray scanner, a high speed area camera, a line scan camera, or a combination thereof. In some embodiments of the process, at least a portion of the scanning is conducted separately from the depositing of the thermosetting resin along the deposition path and/or at least a portion of the scanning is conducted during the depositing of the thermosetting resin along the deposition path.

In some embodiments of the process the perturbation profile comprises, consists of, or consists essentially of each perturbation detected in the one or more layers of the thermosetting resin. In some embodiments of the process the perturbation profile comprises, consists of, or consists essentially of each perturbation detected in one or more portions of the one or more layers of the thermosetting resin, e.g, at various points, quadrants, and/or the like. In some embodiments of the process the perturbation profile comprises, consists of, or consists essentially of an average of each perturbation detected in the one or more layers of the thermosetting resin, which may be a weighted average and/or may include one or more mathematical transformations. In some embodiments of the process the perturbation profile comprises, consists of, or consists essentially of an average of each perturbation detected in one or more portions of the one or more layers of the thermosetting resin. In some embodiments of the process the perturbation profile comprises, any combination of the above.

In some embodiments of the process the adjusting of one or more deposition parameters includes adjustments to the deposition path. In some embodiments of the process the adjusting of one or more deposition parameters includes adjustments of a bead spacing at which the thermosetting resin is deposited onto a substrate or at least a portion of another layer. In some embodiments of the process the adjusting of one or more deposition parameters includes adjustments of a tip height determined as a distance of the extrusion nozzle above the layer and/or substrate on which the thermosetting resin is deposited during at least a portion of the deposition path. In some of such embodiments, the tip height is adjusted partially based on measured height of a deposited layer provided by the scanner to prevent accumulation of the thermosetting resin on the extrusion nozzle; to prevent contact of the extrusion nozzle with the deposited layer of thermosetting resin, or a combination thereof. This may also include adjustment of the deposition path and/or other steps to clean the extrusion nozzle to remove any accumulated material from the nozzle.

In some embodiments of the process the adjusting of one or more deposition parameters includes adjustments of an extrusion percent at which the thermosetting resin is extruded during at least a portion of the deposition path, based on a total amount of the thermosetting resin predicted to be required during the portion of the deposition path according to the predefined design. In some embodiments of the process the adjusting of one or more deposition parameters includes adjustments of a flow rate of the thermosetting resin through the extrusion nozzle during at least portion of the deposition path.

In some embodiments of the process the adjusting of one or more deposition parameters includes adjustments of a pumping pressure applied to the thermosetting resin within the extrusion nozzle during at least portion of the deposition path. In some of such embodiments, the pumping pressure applied to the thermosetting resin within the extrusion nozzle during at least portion of the deposition path is reduced or negative in an amount sufficient to prevent flow of the thermosetting resin through the extrusion nozzle during the portion of the deposition path. E.g., the pump is run in reverse.

In some embodiments of the process the adjusting of one or more deposition parameters includes adjustments of a translation speed of the extrusion nozzle along at least a portion of the deposition path. In some embodiments of the process the adjusting of one or more deposition parameters includes adjustments of a composition of the thermosetting resin being deposited. In some of such embodiments, the adjusting of the composition of the thermosetting resin being deposited includes adjusting a residence time and/or a temperature of the plurality of components within the mixing chamber.

In embodiments of the process, the adjustment of the composition of the thermosetting resin comprises increasing an amount of one or more of the plurality of components into the mixing chamber relative to at least one other component. In embodiments of the process the adjustment of the composition of the thermosetting resin comprises directing at least one additional component into the mixing chamber, and/or ceasing the directing of at least one of the components being directed into the mixing chamber.

In embodiments of the process the adjustment of the composition of the thermosetting resin comprises directing at least a third reactive component e.g, a fourth, a fifth, etc. into the mixing chamber. In embodiments of the process the adjustment of the composition of the thermosetting resin comprises directing one or more components into the mixing chamber effective to change a cure rate of the thermosetting resin being deposited.

In embodiments of the process the adjustment of the composition of the thermosetting resin is effective to change a physical and/or a rheological property of the thermosetting resin being deposited. In embodiments of the process, the adjustment of the composition of the thermosetting resin is effective to change a viscosity of the thermosetting resin being deposited. In some of such embodiments, the adjustment of the composition of the thermosetting resin effective to change a viscosity of the thermosetting resin being deposited comprises:
i) beginning the directing one or more other components into the mixing chamber;
ii) increasing and/or decreasing an amount of one or more of the plurality of components being directed into the mixing chamber relative to another component;
iii) stopping the directing of one or more components into the mixing chamber;
iv) adjusting a residence time of the plurality of components within the mixing chamber; v) adjusting a temperature of the plurality of components within the mixing chamber; or a combination thereof.

In some embodiments of the process, the adjustment of the composition of the thermosetting resin is effective to change a viscoelasticity of the thermosetting resin being deposited.

In one or more embodiments of the process, the predefined design comprises one or more necessary attributes and one or more optional attributes, and wherein the depositing of the subsequent one or more layers of thermosetting resin according to the adjusted deposition parameters forms a 3D object comprising optional attributes which differs from the predefined design, and which comprises all of the necessary attributes of the predefined design. In some of such embodiments, the perturbation profile includes information directed to a height of the deposited layers of the thermosetting resin, and wherein the adjusting of the one or more deposition parameters of one or more subsequent layers based the perturbation profile results in a 3D object comprising at least one portion that differs in a total height from the predefined design by a distance of less than or equal to about a height of one of the deposited layers.

In alternative embodiments, a 3D object is produced according to any one or combination of embodiments of the process disclosed herein.

Applicant has surprisingly discovered that controlling the tip height in relation to the previous layer printed may provide 3D printed objects having a smooth finish, high resolution, and a precise edge. G-code may be sliced with a fixed layer height. In embodiments, the tip extruding resin may be above the resin layer being printed by a slight amount. If the G-Code layer height (predicted height) is off from the true layer height defined by the geometry and mechanical properties of the resin, the error of the height of the tip in relation to the layer being printed may grow over successive layers. Regardless of the direction of the error (low or high) having an error between the sliced height and the printed height may result in a part that has dimensional errors.

The tip may be too low if the current layer being deposited is higher than the bottom of the tip of the nozzle. This results in resin buildup on the nozzle itself. This buildup may accumulate and cause defects in the printed part. For example, the accumulation cause by an error in the tip height may drag resin from adjacent beads in the part and cause ripples in the part. If the layer height error is high enough, the tip may drag through a previous layer creating ridges and valleys in the part. Even if this accumulation is dealt with, a tip height that is too low is generally caused by the G-Code layer height not being the actual layer height of the properties of the resin. If this error accumulates over time getting lower and lower, the tip may start digging into the previous layers of resin.

By following embodiments of the disclosure, it is possible to 3D print an object having a smooth finish, high resolution, and a precise edge.

Embodiments of the disclosed processes may be used in the disclosed systems. Embodiments of the disclosed systems may be used in the disclosed processes.

The present disclosure also relates to a 3D object produced according to the disclosed processes. The present disclosure also relates to a 3D object produced using the disclosed system.

Various examples and embodiments of the subject matter disclosed are possible and will be apparent to a person of ordinary skill in the art, given the benefit of this disclosure. In this disclosure reference to “some embodiments,” “certain embodiments,” “certain exemplary embodiments” and similar phrases each means that those embodiments are non-limiting examples of the inventive subject matter, and there may be alternative embodiments which are not excluded.

The articles “a,” “an,” and “the” refer to one or more than one (i.e., to at least one) of the grammatical object of the article. By way of example, “an element” means one element, at least one element, or more than one element.

As used herein, the term “extrusion percent” means the percent of material extruded in one layer compared to the 100% value generated by the slicer and the G-code, which may be represented by a predicted amount of material extruded for a layer. For example, if a layer was extruded using 105% of the predicted material, the subsequent layer could remedy this overextrusion by extruding 95% of the material extruded in previous layer.

As used herein, the term “layer translation path” means the path that is traversed by the printhead or extrusion nozzle while depositing material in the layer. In embodiments, the path may be followed to deposit material in the areas that have been specified by the slicing application. In embodiments, the layer translational path may be chosen such that a minimum amount of time elapses before an adjacent bead is placed. In embodiments, this minimum amount of time may be from about 1 second to about 60 minutes. In embodiments, this minimum amount of time may be from about 5 seconds to about 1 minute. In embodiments, this minimum amount of time may be about 1 second, about 5 seconds, about 10 seconds, about 15 seconds, about 20 seconds, about 25 seconds, about 30 second, about 35 seconds, about 40 seconds, about 45 seconds, about 50 seconds, about 60 second, about 90 seconds, about 2 minutes, about 3 minutes, about 4 minutes, about 5 minutes, or any ranges between the specified values. If an insufficient amount of time has elapsed, the beads may combine and form a bead with a different aspect ratio than a single bead. For purposes herein, the aspect ratio of a bead is defined as the height of the bead divided by a cross-sectional width of the bead determined perpendicular to the direction of the deposition path. In embodiments, the algorithm which constructs a translation or deposition path may control a layer deposition or translation path such that a bead deformation does not occur when beads are placed adjacent to one another.

As used herein, the terms “thermoset,” “thermoset product,” and “thermoset material” are used interchangeably and refer to a non-flowable or non-pumpable (not able to determine a Brookfield viscosity) reaction product of at least two chemicals which form a covalently bonded crosslinked or polymeric network having a determined shape or confirmation, i.e., a set or cured thermosetting resin. In contrast to thermoplastics, which can be melted and reshaped or pumped and then cooled to form a solid material, a thermoset product described herein irreversibly solidifies, cures or sets.

As used herein, the thermosetting resin or thermosetting resin, while comprising a covalently bonded crosslinked or polymeric network, is flowable or pumpable, and is appreciably reactive, e.g., it is only partially cured, and comprises unreacted hydroxyl, amine, and/or isocyanate moieties or functionality that gives an appreciable hydroxyl number, amine (NH) number, or isocyanate (NCO) number via one or more analytical methods, e.g., via titration. In one embodiment, a thermosetting resin may have a viscosity below about 3,000,000 cp when determined according to the Brookfield method at 25° C. In one embodiment, thermosetting resin may have a molecular weight of no greater than about 100,000 g/mol, when determined as weight averaged molecular weight (M_{W}) according to methods commonly known and utilized in the art for this purpose, e.g., via size exclusion liquid chromatography with a variety of detectors using standard reference compounds.

As used herein, the term “perturbation” includes any variation from a level layer or from a predicted layer height. A perturbation may be higher height than expected or lower height than expected. A perturbation may be any geometry. A perturbation may be an undesired geometry in addition to the printed layer or a variance in the absence of material verses the expected layer.

As used herein, the term “perturbation profile” refers to the summation of or an analysis of the perturbations scanned, sensed, and/or detected in, within and/or on a layer. The perturbation profile may be calculated by any number of ways, and any range of resolution and/or specificity. For example, the perturbation profile may include each perturbation on a layer, above or below predetermined criteria, an average of all the perturbations on at least a portion of a layer or the entire layer, an average of all and/or a portion of the perturbations on a subset of a layer (e.g., within a quadrant, within a half, or within any numeric subdivision possible).

As used herein, the term “predicted height” refers to the height of a layer of thermosetting resin represented by the goal or planned layer height; it is the height of a layer based on the instructions received by, sent to, or processed by the controller, e.g., one or more printer controllers. If the actual printing matched the instructions, the actual height would equal the predicted height.

As used herein, the term “tip height” refers to the distance between the extrusion nozzle and the printing platform for the first layer, and the height of the layers of previously printed material for all of the subsequent layers of the 3D object being produced. Adjusting the tip height may be achieved by moving the extrusion nozzle up or down, moving the print bed up or down, changing properties of the thermosetting resin, and/or the like, wherein the distance between the end of the extrusion nozzle and the top of the 3D object being printed may be changed.

### Three-Dimensional (3D) Object Production Process and System

In embodiments, the present disclosure is directed to a three-dimensional (3D) object production process comprising: providing a thermoset printing apparatus comprising: a mixing chamber to receive and contact, e.g., mix the plurality of components, e.g, at least a first reactive component and a second reactive component, to form or provide a thermosetting resin, an extrusion nozzle to deliver the thermosetting resin to form a 3D object, at least one actuator coupled to the extrusion nozzle to move the extrusion nozzle when delivering the thermosetting resin to form the 3D object, a controller comprising one or more processors and coupled to the extruded thermoset printing apparatus, and a scanner; and depositing the thermosetting resin to form the 3D object, wherein the depositing comprises depositing a layer of thermosetting resin according to a first deposition path?, scanning the layer of thermosetting resin to detect a perturbation, determining a perturbation profile, adjusting the path of one or more subsequent layers based on the perturbation profile, and depositing the subsequent layer of thermosetting resin according to the adjusted path or conditions?.

In embodiments, the present disclosure is directed to a system comprising a thermoset printing apparatus comprising: a mixing chamber to receive and mix at least a first reactive component and a second reactive component to provide a thermosetting resin, an extrusion nozzle to deliver the thermosetting resin to form a 3D object, at least one actuator coupled to the extrusion nozzle to move the extrusion nozzle when delivering the thermosetting resin to form the 3D object, a controller comprising one or more processors and coupled to the extruded thermoset printing apparatus, and a scanner; wherein the controller is configured to: produce the 3D object based on a 3D object design and deposit the thermosetting resin to form the 3D object, wherein the depositing comprises depositing a layer of thermosetting resin, scanning the layer of thermosetting resin to detect a perturbation, adjusting the path of a subsequent layer based on a perturbation profile, and depositing the subsequent layer of thermosetting resin.

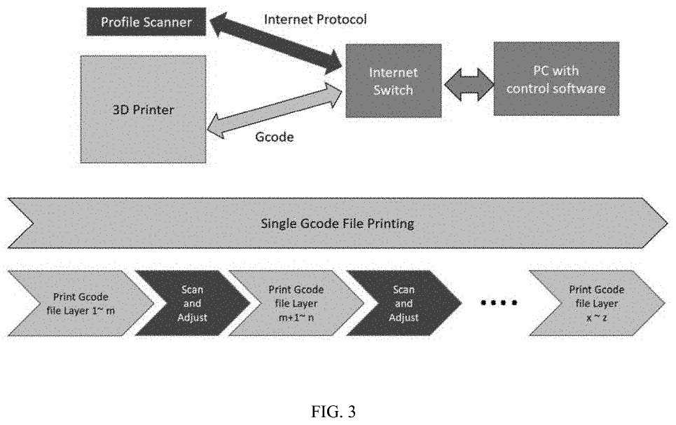

FIG. 3 depicts an embodiment of the adaptive printing process. In embodiments, software may construct G-code commands strings and send them via http protocols. In addition, the software may read G-code files and send printing instructions. The software may communicate with a scanner (e.g., a laser scanner). The software may synchronize the printing motion and scanning process (including data acquisition). A user may specify the single position for scanning of an area for a 2D scan and/or a 3D scan. In embodiments of the process, the G-code file may be modified by adding additional formatted comments for triggering a scan intervention. The scanning result may be compared with expectation or prediction, which may allow for determining the height of the next layer. An adjustment for the next layer to match the difference may be automatically implemented.

In embodiments, the scanner may be any device or method that allows for an analysis of the perturbations on a layer, including any defects or topographical variation. In embodiments, the scanner may be at least one of an optical scanner, a laser scanner, a profile sensor, a point laser sensor, a confocal displacement sensor, an X-ray scanner, a high speed area camera, and/or a line scan camera. In embodiments, the scanner may be a profile sensor, a point laser sensor (e.g., Keyence LK-G3000 series (KEYENCE CORP. OF AMERICA, Itaskca Ill.), which may measure a single spot instead of a line profile.), a confocal displacement sensor (e.g, Keyence CL-3000 series, wherein the measurement principle utilizes light dispersion to determine the surface topography), a high speed area or line scan camera (e.g., https://www.teledynedalsa.com, last visited Nov. 23, 2021) which may be used to determine the surface topography from the focal length.

Accordingly, in embodiments of a 3-dimensional (3D) object production process, the scanner may comprise an optical scanner, a laser scanner, a profile sensor, a point laser sensor, a confocal displacement sensor, an X-ray scanner, a high speed area camera, a line scan camera, or a combination thereof.

In embodiments, at least a portion of the scanning of the previously deposited layer or layers is conducted separately from the depositing of the thermosetting resin along the deposition path. In other embodiments, at least a portion of the scanning of the previously deposited layer or layers is conducted during the depositing of the thermosetting resin along the deposition path. For example the scanner may be located proximate to the extruder nozzle and may obtain the scanned information on a printed portion of the layer or layers essentially simultaneously with another portion of the layer being printed. Any combination of scanning as a separate step or while printing may be utilized.

The scanning may comprise any number of measurement within a layer. In embodiments, the scanning comprises scanning the entire layer. In embodiments, the scanning comprises scanning at least one point on the layer. In embodiments, the scanning comprises scanning at least one point in each quadrant on the layer.

Based on an analysis of the perturbations, a perturbation profile is determined. In embodiments, the perturbation profile comprises an average of the perturbations detected in the layer of thermosetting resin. In embodiments, the perturbation profile comprises each perturbation detected in the layer of thermosetting resin. In embodiments, the perturbation profile comprises a quadrant average of the perturbations detected in the layer of thermosetting resin.

In embodiments, the process comprises adjusting the tip height of the extrusion nozzle. In embodiments, adjusting the path of the subsequent layer comprises adjusting a tip height of the extrusion nozzle. In embodiments, the process comprises adjusting the tip height of the extrusion nozzle by and amount relative to the size (surface area) of the printing orifice of the extrusion nozzle to the distance between the end of the nozzle and the layer or substrate onto which the thermosetting resin will be deposited (tip height), from about 1:1000 to about 1000:1, wherein the ratio is determined as the surface area (mm²) to tip height (mm), e.g, from about 1 mm² to 1000 mm height, to about 1000 mm² to 1 mm height. In some embodiments, this ratio is from about 1:100 to about 100:1, or from about 1:20 to about 20:1, or from about 1:10 to about 10:1.

In embodiments, process comprises adjusting the tip height of the extrusion nozzle by about 0.01 mm to about 10 mm. In embodiments, process comprises adjusting the tip height of the extrusion nozzle to a distance of greater than or equal to about 0.1 mm, or 0.5 mm, or 1 mm, or 1.5 mm, or 2 mm, to less than or equal to about 10 mm, or 10 mm, or 7 mm, or 5 mm, or 3 mm, or 2 mm. In embodiments, the process comprises adjusting the tip height of the extrusion nozzle by about 0.2 mm to about 0.5 mm.

In embodiments, process comprises adjusting the tip height of the extrusion nozzle by about 0.01 mm, about 0.05 mm, about 0.075 mm, about 0.09 mm, about 0.1 mm, about 0.125 mm, about 0.15 mm, about 0.175 mm, about 0.2 mm, about 0.225 mm, about 0.25 mm, about 0.275 mm, about 0.3 mm, about 0.35 mm, about 0.4 mm, about 0.5 mm, about 0.6 mm, about 0.7 mm, about 0.8 mm, about 0.9 mm, about 1 mm, about 1.5 mm, about 2 mm, or any ranges between the specified values.

In embodiments, the tip height during the depositing of the subsequent layer of thermosetting resin may be higher than the tip height during the depositing of the layer of thermosetting resin. In embodiments, the tip height during the depositing of the subsequent layer of thermosetting resin may be lower than the tip height during the depositing of the layer of thermosetting resin. In embodiments, the tip height during the depositing of the subsequent layer of thermosetting resin may be adjusted based on the perturbation profile comprising an average of the perturbations detected in the layer of thermosetting resin. In embodiments, the tip height during the depositing of the subsequent layer of thermosetting resin may be adjusted based on the perturbation profile comprising each perturbation detected in the layer of thermosetting resin. In embodiments, the tip height during the depositing of the subsequent layer of thermosetting resin may be adjusted based on the perturbation profile comprising a quadrant average of the perturbations detected in the layer of thermosetting resin.

In embodiments, the tip height may be adjusted by moving the print bed. In embodiments, the tip height may be adjusted by moving the extrusion nozzle. In embodiments, the tip height may be adjusted by moving the print bed and the extrusion nozzle.

In embodiments, the process comprises an extrusion percent of thermosetting resin. In embodiments, adjusting the path of the subsequent layer comprises adjusting an extrusion percent of thermosetting resin. In embodiments, the process comprises adjusting an extrusion percent of thermosetting resin from about 0% to about 400%. For purposes herein, the extrusion percent refers to proportion of thermosetting resin extruded relative to the amount predicted as being required by the predefined design, wherein an extrusion percent less than 100% represents deposition of less than the predicted amount, an extrusion percent of 100% represents deposition of the predicted amount, and an extrusion percent of greater than 100% represents deposition of more of the thermosetting resin than predicted by the predefined design. In embodiments, the process comprises adjusting an extrusion percent of thermosetting resin from about 10%, or 25%, or 50%, or 75% or 80%, or 90%, or 95% to about 105%, or 110%, or 120%, or 150%, or 200%, or 300% or 350%, based on amount required by the to the predefined design. In embodiments, the process comprises adjusting an extrusion percent of thermosetting resin from about 50% to about 200%. In embodiments, the process comprises adjusting an extrusion percent of thermosetting resin from about 75% to about 150%.

In embodiments, the process comprises adjusting an extrusion percent of thermosetting resin by about 0%, about 25%, about 50%, about 75%, about 100%, about 125%, about 150%, about 175%, about 200%, about 225%, about 250%, about 275%, about 300%, about 325%, about 350%, about 375%, about 400%, or any ranges between the specified values.

In embodiments, the extrusion percent during the depositing of the subsequent layer of thermosetting resin may be higher than extrusion percent during the depositing of the layer of thermosetting resin. In embodiments, the extrusion percent during the depositing of the subsequent layer of thermosetting resin may be lower than extrusion percent during the depositing of the layer of thermosetting resin. In embodiments, the extrusion percent during the depositing of the subsequent layer of thermosetting resin may be adjusted based on the perturbation profile comprising an average of the perturbations detected in the layer of thermosetting resin. In embodiments, the extrusion percent during the depositing of the subsequent layer of thermosetting resin may be adjusted based on the perturbation profile comprising each perturbation detected in the layer of thermosetting resin. In embodiments, the extrusion percent during the depositing of the subsequent layer of thermosetting resin may be adjusted based on the perturbation profile comprising a quadrant average of the perturbations detected in the layer of thermosetting resin.

In embodiments, the process comprises adjusting a flow rate of the thermosetting resin. In embodiments, adjusting the path of the subsequent layer comprises adjusting a flow rate of the thermosetting resin.

In embodiments, the flow rate during the depositing of the subsequent layer of thermosetting resin may be higher than the flow rate during the depositing of the layer of thermosetting resin. In embodiments, the flow rate during the depositing of the subsequent layer of thermosetting resin may be lower than the flow rate during the depositing of the layer of thermosetting resin. In embodiments, the flow rate during the depositing of the subsequent layer of thermosetting resin may be adjusted based on the perturbation profile comprising an average of the perturbations detected in the layer of thermosetting resin. In embodiments, the flow rate during the depositing of the subsequent layer of thermosetting resin may be adjusted based on the perturbation profile comprising each perturbation detected in the layer of thermosetting resin. In embodiments, the flow rate during the depositing of the subsequent layer of thermosetting resin may be adjusted based on the perturbation profile comprising a portion average, e.g., a quadrant average of the perturbations detected in the layer of thermosetting resin.

In embodiments, a flow rate of the thermosetting resin through the extrusion nozzle may be adjusted to optimize the flow rate through the extrusion nozzle. Depending on the properties of the reactive components and the geometry of the desired final 3D product, the flow rate adjustment may vary. As used herein, the term “flow rate through the extrusion nozzle” means a volumetric flow rate, or a volume of material in mm³ that is pushed through the nozzle in a second. The rate may vary depending on the tip diameter. In embodiments, the maximum rate may be set by the strength of the pump on the printer. In embodiments, the flow rate may be controlled by the setting adjusting the pump displacement.

In embodiments, the flow rate through the extrusion nozzle may be from about 0.1 mm³/s to about 200 mm³/s. In embodiments, the flow rate may be from about 1 mm³/s to about 100 mm³/s. In embodiments, the flow rate may be from about 5 mm³/s to about 50 mm³/s. In embodiments, the flow rate may be about 0 about 0.1 mm³/s, about 0.5 mm³/s, about 1 mm³/s, about 5 mm³/s, about 10 mm³/s, about 15 mm³/s, about 20 mm³/s, about 25 mm³/s, about 30 mm³/s, about 35 mm³/s, about 40 mm³/s, about 45 mm³/s, about 50 mm³/s, about 100 mm³/s, about 150 mm³/s, about 200 mm³/s, about 500 mm³/s, about 1000 mm³/s, or any ranges between the specified values. In embodiments, the flow rate of the material, combined with the volume of the mixing chamber, may set the extent of reaction of the material at the time that it leaves the nozzle. For example, if the printer is printing at 0.1 mm³/s and the mixer has a volume of 2 mm³, then the reaction mixture may be, on average, about 20 seconds into its reaction. If the flow rate is decreased to 0.01 mm³/s, then the reaction mixture may be, on average, about 200 seconds into its reaction.

In embodiments, the process comprises adjusting a viscosity of the thermosetting resin. In embodiments, adjusting the path of the subsequent layer includes adjusting a viscosity of the thermosetting resin at one or more locations along the path. In embodiments, the viscosity during the depositing of the subsequent layer of thermosetting resin may be lower than the viscosity during the depositing of the layer of thermosetting resin. In embodiments, the viscosity during the depositing of the subsequent layer of thermosetting resin may be adjusted based on the perturbation profile comprising an average of the perturbations detected in the layer of thermosetting resin. In embodiments, the viscosity during the depositing of the subsequent layer of thermosetting resin may be adjusted based on the perturbation profile comprising each perturbation detected in the layer of thermosetting resin. In embodiments, the viscosity during the depositing of the subsequent layer of thermosetting resin may be adjusted based on the perturbation profile comprising a quadrant average of the perturbations detected in the layer of thermosetting resin. In embodiments, the viscosity of the thermosetting resin may be at least about 60 centipoise (cP). In embodiments, the viscosity of the thermosetting resin may be from about 500 cP to about 500,000 cP. In embodiments, the viscosity of the thermosetting resin may be below about 3,000,000 cP. When determined according to the Brookfield method or any other suitable method, at 25° C.

In embodiments, the process may comprise depositing the thermosetting resin using any bead spacing. In embodiments, the depositing compromises a bead spacing (need definition) of the thermosetting resin from about 0.1 mm to about 2 mm. In embodiments, the depositing compromises a bead spacing of the thermosetting resin from about 0.2 mm to about 1 mm. In embodiments, the depositing compromises a bead spacing of the thermosetting resin from about 0.4 mm to about 0.8 mm.

In embodiments, the depositing compromises a bead spacing of the thermosetting resin less than about 1 mm. In embodiments, the depositing compromises a bead spacing of the thermosetting resin less than about 0.8 mm. In embodiments, the depositing compromises a bead spacing of the thermosetting resin less than about 0.7 mm. In embodiments, the bead spacing may be about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 1.2 mm, about 1.4 mm, about 1.6 mm, about 1.8 mm, or about 2 mm, or any ranges between the specified values.

In embodiments, the process may comprise depositing the thermosetting resin using a selected translation speed (need definition). In embodiments, the depositing compromises a translation speed of at least about 100 mm/min. (This is likely a term of art. Is this linear velocity, what about angular velocity printing a circle? In embodiments, the depositing compromises a translation speed of at least about 500 mm/min. In embodiments, the depositing compromises a translation speed of at least about 1000 mm/min. In embodiments, the depositing compromises a translation speed of at least about 5000 mm/min. In embodiments, the depositing compromises a translation speed of from about 100 mm/min to about 5000 mm/min. In embodiments, the depositing compromises a translation speed of from about 800 mm/min to about 2500 mm/min. In embodiments, the depositing compromises a translation speed of from about 500 mm/min to about 1000 mm/min.

In embodiments, the translation speed may be about 25 mm/min, about 50 mm/min, about 100 mm/min, about 25 mm/min, about 50 mm/min, about 100 mm/min, about 25 mm/min, about 50 mm/min, about 100 mm/min, about 200 mm/min, about 300 mm/min, about 400 mm/min, about 500 mm/min, about 600 mm/min, about 700 mm/min, about 800 mm/min, about 900 mm/min, about 1000 mm/min, about 1500 mm/min, about 2000 mm/min, about 2500 mm/min, about 3000 mm/min, about 3500 mm/min, about 4000 mm/min, about 4500 mm/min, about 5000 mm/min, about 5500 mm/min, about 6000 mm/min, about 6500 mm/min, about 7000 mm/min, about 7500 mm/min, about 8000 mm/min, about 8500 mm/min, about 9000 mm/min, about 9500 mm/min, about 10000 mm/min, or any ranges between the specified values.

In embodiments, the thermosetting resin may behave a particular viscoelasticity. In contrast to purely viscose materials which resist shear flow when a stress is applied, and elastic materials which stretch when stress is applied and then immediately return to their original state once the stress is removed, viscoelastic materials exhibit both viscous and elastic characteristics when undergoing deformation. Typically exhibit time-dependent strain. Accordingly, viscoelastic materials may have both solid-like and liquid-like properties.

In embodiments, the change in viscosity of the mixed composition, and thus the extent of the reaction, in a curing process may be determined by measuring variation of the elastic modulus using a rheometer according to known methods in the art. Dynamic mechanical analysis may be utilized to measure the storage modulus (G′) and the loss modulus (G″). The variation of G′ and G″ in time may indicate the extent of the curing reaction. When the system is liquid, the storage modulus is very low: the system behaves like a liquid. Then the reaction continues and the system starts to react more like a solid: the storage modulus increases.

In embodiments, viscoelasticity is determined may by the ratio of storage modulus to loss modulus. If the thermosetting resin is highly elastic, once a flow stop command is executed during a printing process, the material may spring back into the printhead. In contrast, if the material is highly viscous, the material may continue flowing out of the printhead until the pressure forcing the material is relaxed both externally and within the thermoset material. This viscous response is referred to herein as may the thermosetting resin's latency. The speed of the response of the material to a force change from positive pressure to light suction stopping flow may depends on the viscosity of the thermosetting resin, which is related to other factors. In embodiments, a thermosetting resin has a low enough viscosity such that it may flow out of the printhead unless a light suction is supplied. In embodiments, the viscoelasticity may have a G′/G″ (often referred to as tan delta) greater than about 0.1, about 0.2, about 0.3, about 0.4, about 0.5, about 0.6, about 0.7, about 0.8, about 0.9 or about 1, or any ranges between the specified values. [this needs more]

In embodiments, depositing the subsequent layer of thermosetting resin comprises depositing an amount of thermosetting resin to reach a predicted height of the layer of thermosetting resin. This depositing may include filling in any gaps that occurred that deviated from the predicted height. In embodiments, this is not depositing of an entire subsequent layer, but is a depositing at the positions having a less than predicted height.

In embodiments, depositing the subsequent layer of thermosetting resin comprises depositing an amount of thermosetting resin that results in forming a layer having an actual height this is greater than a predicted and/or intended height based on the design of the layer of thermosetting resin. Such depositing may include filling in any gaps that occurred that deviate from the predicted height. This depositing may further include filling in any variations in regions from the predicted height to the actual height (i.e., in some locations in the layer, the predicted height was equal to the actual height, but because there were locations where the actual height was higher than the predicted height, material may be added to produce a level layer). This may further require redetermining or amending subsequent depositions to account for such perturbations.

In embodiments, the process comprises scanning the subsequent layer of thermosetting resin to detect a perturbation, adjusting the path of a second subsequent layer based on a perturbation profile, and depositing the second subsequent layer or a portion of a layer of thermosetting resin. The process may be repeated for any number of layers. In embodiments, the scanning, adjusting, and depositing of a subsequent layer occurs at each layer in a multilayered 3D object. In embodiments, the scanning, adjusting, and depositing of a subsequent layer occurs at every second, every third, every fourth, every fifth, or any number layer in a multilayered 3D object.

In embodiments, the thermoset printing apparatus may comprise use of a pump. In embodiments, the thermoset printing apparatus may comprise a suction pump. In embodiments, the process comprises applying suction during the depositing.

In embodiments, the suction may be applied for any amount of time. In embodiments, the process comprises applying suction for at least about 1 second. In embodiments, the process comprises applying suction for at least about 10 seconds. In embodiments, the process comprises applying suction for at least about 30 seconds. In embodiments, the process comprises applying suction for at least about 1 minute. In embodiments, the process comprises applying suction for from about 1 second to about 5 minutes. In embodiments, the process comprises applying suction for from about 5 seconds to about 1 minute. In embodiments, the process comprises applying suction for from about 10 second to about 30 seconds.

In embodiments, the process comprises applying suction for about 1 second, about 2 seconds, about 3 seconds, about 4 seconds, about 5 seconds, about 6 seconds, about 7 seconds, about 8 seconds, about 9 seconds, about 10 seconds, about 11 seconds, about 12 seconds, about 13 seconds, about 14 seconds, about 15 seconds, about 16 seconds, about 17 seconds, about 18 seconds, about 19 seconds, about 20 seconds, about 21 seconds, about 22 seconds, about 23 seconds, about 24 seconds, about 25 seconds, about 26 seconds, about 27 seconds, about 28 seconds, about 29 seconds, about 30 second, about 35 seconds, about 40 seconds, about 45 seconds, about 50 seconds, about 60 second, about 90 seconds, about 2 minutes, about 3 minutes, about 4 minutes, about 5 minutes, or any ranges between the specified values.

In embodiments, the process comprises use of a support. As used herein, the term “support” means an object or material that may provide stability during 3D printing.

In embodiments, the process comprises depositing a support material during the depositing of the thermosetting resin. In embodiments, the support material may be an olefinic material. In embodiments, the olefinic material may be a polyalkylene, such as polyethylene and/or polypropylene. In embodiments, the support may be polylactic acid. In embodiments, the support may be acrylonitrile butadiene styrene (ABS). In embodiments, the support may be an ABS-like UV-curing rapid resin, such as Elegoo Standard resin. In embodiments, the support may comprise polysiloxane polymers or copolymers, e.g., may a silicone mat.

In embodiments, the support may be coated. In embodiments, the support may be coated with a release agent, such as a mold release agent. In embodiments, the support may be coated with a wax, such as a finish paste wax. In embodiments, the support is untreated.

In embodiments, the support may be 3D printed with a fused filament fabrication (FFF) printer. In embodiments, the support may be 3D printed with a stereolithography (SLA) printer. In embodiments, the support may be co-3D printed with the depositing of the 3D object having overhang. In embodiments, the support may be 3D printed prior to depositing the 3D object having overhang.

In embodiments, the process comprises removing the support. In embodiments, the removing may be by melting.

In embodiments, the present disclosure is directed to a 3D object produced by the disclosed processes. In embodiments, the present disclosure is directed to a 3D object produced using the disclosed systems.

In embodiments, the process comprises a third reactive component. In embodiments, the process comprises a fourth reactive component.

Accordingly, in embodiments, a three-dimensional (3D) object production process comprises the steps of: providing a thermoset printing apparatus comprising: a mixing chamber to receive and mix at least a first reactive component and a second reactive component to provide a thermosetting resin, an extrusion nozzle to deliver the thermosetting resin to form a 3D object, at least one actuator coupled to the extrusion nozzle to move the extrusion nozzle when delivering the thermosetting resin to form the 3D object, a controller comprising one or more processors and coupled to the extruded thermoset printing apparatus, and a scanner; and depositing the thermosetting resin to form the 3D object, wherein the depositing comprises depositing a layer of thermosetting resin, scanning the layer of thermosetting resin to detect a perturbation, adjusting the path of a subsequent layer based on a perturbation profile, and depositing the subsequent layer of thermosetting resin.

In embodiments, the scanner comprises at least one of an optical scanner, a laser scanner, a profile sensor, a point laser sensor, a confocal displacement sensor, an X-ray scanner, a high speed area camera, or a line scan camera.

In embodiments, the perturbation profile comprises an average of the perturbations detected in the layer of thermosetting resin. In embodiments, the perturbation profile comprises each perturbation detected in the layer of thermosetting resin. In embodiments, the perturbation profile comprises a quadrant average of the perturbations detected in the layer of thermosetting resin.

In embodiments, the scanning comprises scanning the entire layer. In embodiments, the scanning comprises scanning at least one point on the layer. In embodiments, the scanning comprises scanning at least one point in each quadrant on the layer.

In embodiments, adjusting the path of the subsequent layer comprises adjusting a tip height of the extrusion nozzle. In embodiments, the tip height during the depositing of the subsequent layer of thermosetting resin is higher than the tip height during the depositing of the layer of thermosetting resin. In embodiments, the tip height during the depositing of the subsequent layer of thermosetting resin is lower than the tip height during the depositing of the layer of thermosetting resin. In embodiments, tip height during the depositing of the subsequent layer of thermosetting resin is adjusted based on the perturbation profile comprising an average of the perturbations detected in the layer of thermosetting resin. In embodiments, the tip height during the depositing of the subsequent layer of thermosetting resin is adjusted based on the perturbation profile comprising each perturbation detected in the layer of thermosetting resin. In embodiments, the tip height during the depositing of the subsequent layer of thermosetting resin is adjusted based on the perturbation profile comprising a quadrant average of the perturbations detected in the layer of thermosetting resin.

In embodiments, adjusting the path of the subsequent layer comprises adjusting an extrusion percent of thermosetting resin. In embodiments, the extrusion percent during the depositing of the subsequent layer of thermosetting resin is higher than extrusion percent during the depositing of the layer of thermosetting resin. In embodiments, the extrusion percent during the depositing of the subsequent layer of thermosetting resin is lower than extrusion percent during the depositing of the layer of thermosetting resin. In embodiments, the extrusion percent during the depositing of the subsequent layer of thermosetting resin is adjusted based on the perturbation profile comprising an average of the perturbations detected in the layer of thermosetting resin. In embodiments, the extrusion percent during the depositing of the subsequent layer of thermosetting resin is adjusted based on the perturbation profile comprising each perturbation detected in the layer of thermosetting resin. In embodiments, the extrusion percent during the depositing of the subsequent layer of thermosetting resin is adjusted based on the perturbation profile comprising a quadrant average of the perturbations detected in the layer of thermosetting resin.

In embodiments, adjusting the path of the subsequent layer comprises adjusting a flow rate of the thermosetting resin. In embodiments, the flow rate during the depositing of the subsequent layer of thermosetting resin is higher than the flow rate during the depositing of the layer of thermosetting resin. In embodiments, the flow rate during the depositing of the subsequent layer of thermosetting resin is lower than the flow rate during the depositing of the layer of thermosetting resin. In embodiments, the flow rate during the depositing of the subsequent layer of thermosetting resin is adjusted based on the perturbation profile comprising an average of the perturbations detected in the layer of thermosetting resin. In embodiments, the flow rate during the depositing of the subsequent layer of thermosetting resin is adjusted based on the perturbation profile comprising each perturbation detected in the layer of thermosetting resin. In embodiments, the flow rate during the depositing of the subsequent layer of thermosetting resin is adjusted based on the perturbation profile comprising a quadrant average of the perturbations detected in the layer of thermosetting resin.

In embodiments, the flow rate of the thermosetting resin is from about 0.1 mm³/s to about 200 mm³/s. In embodiments, the flow rate of the thermosetting resin is from about 1 mm³/s to about 100 mm³/s. In embodiments, the flow rate of the thermosetting resin is from about 5 mm³/s to about 50 mm³/s.

In embodiments, adjusting the path of the subsequent layer comprises adjusting a viscosity of the thermosetting resin. In embodiments, the viscosity during the depositing of the subsequent layer of thermosetting resin is higher than the viscosity during the depositing of the layer of thermosetting resin. In embodiments, the viscosity during the depositing of the subsequent layer of thermosetting resin is lower than the viscosity during the depositing of the layer of thermosetting resin. In embodiments, the viscosity during the depositing of the subsequent layer of thermosetting resin is adjusted based on the perturbation profile comprising an average of the perturbations detected in the layer of thermosetting resin. In embodiments, the viscosity during the depositing of the subsequent layer of thermosetting resin is adjusted based on the perturbation profile comprising each perturbation detected in the layer of thermosetting resin. In embodiments, the viscosity during the depositing of the subsequent layer of thermosetting resin is adjusted based on the perturbation profile comprising a quadrant average of the perturbations detected in the layer of thermosetting resin.

In embodiments, the viscosity of the thermosetting resin is at least about 60 centipoise (cP). In embodiments, the viscosity of the thermosetting resin is from about 500 cP to about 500,000 cP. In embodiments, the viscosity of the thermosetting resin is below about 3,000,000 cP.

In embodiments, depositing the subsequent layer of thermosetting resin comprises depositing an amount of thermosetting resin to reach a predicted height of the layer of thermosetting resin. In embodiments, depositing the subsequent layer of thermosetting resin comprises depositing an amount of thermosetting resin to reach beyond a predicted height of the layer of thermosetting resin.

In embodiments, the process comprises scanning the subsequent layer of thermosetting resin to detect a perturbation, adjusting the path of a second subsequent layer based on a perturbation profile, and depositing the second subsequent layer of thermosetting resin.

In embodiments, the depositing compromises a bead spacing of the thermosetting resin from about 0.1 mm to about 2 mm. In embodiments, the depositing compromises a bead spacing of the thermosetting resin less than about 1 mm. In embodiments, the depositing compromises a translation speed of at least about 100 mm/min. In embodiments, the depositing compromises a translation speed of from about 100 mm/min to about 5000 mm/min.

In embodiments, the thermosetting resin comprises a viscoelasticity having a G′/G″ greater than about 0.1.

In embodiments, the thermoset printing apparatus comprises a suction pump. In embodiments, the process comprises applying suction during the depositing. In embodiments, the process comprises applying suction for at least about 1 second. In embodiments, the process comprises applying suction for from about 1 second to about 5 minutes.

In embodiments, the process comprises at least a third reactive component. In embodiments, the process comprises at least a fourth reactive component.

In embodiments, the disclosure is directed to a 3D object produced by the process or any of the embodiments of the process.

### Thermosetting Resin

The thermosetting resin according to embodiments of the disclosure may comprise a plurality of components both the reactive components of the thermosetting resins and other materials, modifiers, additives, extenders, accelerators, retarders, and/or the like, required for the intended purpose.

In embodiments, the thermosetting resin may comprise monomers comprising one or more isocyanate moieties, oligomers comprising isocyanate moieties, referred to herein as “isocyanate prepolymers”, monomers and/or oligomers capable of forming urethane moieties, e.g., a polyurethane, monomers and/or oligomers comprising or capable of forming urea moieties, e.g, a urea-containing polymer, monomers and/or oligomers comprising a plurality of hydroxyl functional groups, e.g, polyol monomers and/or polyol prepolymer, monomers and/or oligomers comprising a plurality of primary and/or secondary amine functional groups, e.g., polyamine monomers and/or polyamino prepolymers, and/or monomers and/or oligomers comprising at least one terminal hydroxyl functional group, and/or monomers and/or oligomers comprising at least one amine functional group comprising a liable hydrogen reactive with an isocyanate.

In embodiments, the thermosetting resin comprises one or more monomers comprising an isocyanate functional group. In embodiments, the thermosetting resin comprises an isocyanate prepolymer. In embodiments, the thermosetting resin comprises one or more monomers comprising a urethane functional group. In embodiments, the thermosetting resin comprises a urethane prepolymer. In embodiments, the thermosetting resin comprises one or more monomers comprising a urea functional group. In embodiments, the thermosetting resin comprises a urea prepolymer. In embodiments, the thermosetting resin comprises one or more monomers comprising a plurality of hydroxyl functional groups. In embodiments, the thermosetting resin comprises one or more polyol prepolymers. In embodiments, the thermosetting resin comprises one or more monomers comprising primary and/or secondary amine functional groups. In embodiments, the thermosetting resin comprises an amine prepolymer. In embodiments, the thermosetting resin comprises one or more monomers or oligomers comprising at least one terminal hydroxyl group. In embodiments, the thermosetting resin comprises one or more monomers or oligomers comprising at least one amine functional group comprising an isocyanate reactive hydrogen.

In embodiments, the thermosetting resin may be a urethane and/or urea-containing polymer. In embodiments, a urethane and/or urea-containing polymer may be a polymer which contains urethane groups (—NH—(C═O)—O—) as part of the polymer backbone chain. The urethane linkage may be formed by reacting isocyanate groups (—N═C═O) with hydroxyl groups (—OH). A polyurethane may be produced by the reaction of an isocyanate containing at least two isocyanate groups per molecule with a compound having terminal hydroxyl groups. In embodiments, an isocyanate comprising, on average, two isocyanate groups per molecule may be reacted with a compound having, on average, at least two terminal hydroxyl groups per molecule.

In embodiments, a urethane and/or urea-containing polymer may be a polymer which contains urea groups (—NH—(C═O)—NH—) as part of the polymer chain. A urea linkage may be formed by reacting isocyanate groups (—N═C═O) with amine groups (e.g., —N(R′)₂), where each R′ is independently hydrogen or an aliphatic, olefinic, alicyclic and/or aromatic moiety or functional group (typically a (C₁-C₄) alkyl group)). A polyurea may be produced by the reaction of an isocyanate containing at least two isocyanate groups per molecule with a compound having terminal amine groups.

For purposes herein, the term “substituted” refers to a hydrogen atom and/or a carbon atom in the base structure that has been replaced with a hydrocarbyl radical, and/or a functional group, and/or a heteroatom or a heteroatom containing group. For purposes herein, a heteroatom is defined as any atom other than carbon and hydrogen. For example, methyl cyclopentadiene (Cp) is a Cp group, which is the base structure, substituted with a methyl radical, which may also be referred to as a methyl functional group, ethyl alcohol is an ethyl group, which is the base structure, substituted with an —OH functional group, and pyridine is a phenyl group having a carbon in the base structure of the benzene ring substituted with a nitrogen atom.

For purposes herein, aliphatic radicals (also referred to as aliphatic moieties, may be independently selected from substituted or unsubstituted methyl, ethyl, ethenyl and isomers of propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, propenyl, butenyl, pentenyl, hexenyl, heptenyl, octenyl, nonenyl, decenyl, undecenyl, dodecenyl, tridecenyl, tetradecenyl, pentadecenyl, hexadecenyl, heptadecenyl, octadecenyl, nonadecenyl, eicosenyl, heneicosenyl, docosenyl, tricosenyl, tetracosenyl, pentacosenyl, hexacosenyl, heptacosenyl, octacosenyl, nonacosenyl, triacontenyl, propynyl, butynyl, pentynyl, hexynyl, heptynyl, octynyl, nonynyl, decynyl, undecynyl, dodecynyl, tridecynyl, tetradecynyl, pentadecynyl, hexadecynyl, heptadecynyl, octadecynyl, nonadecynyl, eicosynyl, heneicosynyl, docosynyl, tricosynyl, tetracosynyl, pentacosynyl, hexacosynyl, heptacosynyl, octacosynyl, nonacosynyl, and triacontynyl.

For purposes herein, the moieties also include isomers of saturated, partially unsaturated and aromatic cyclic structures wherein the radical may additionally be subjected to the types of substitutions described above. The term “aryl”, “aryl radical”, and/or “aryl group” refers to aromatic cyclic structures, which may be substituted with other radicals and/or functional groups as defined herein. Examples of aryl radicals include: acenaphthenyl, acenaphthylenyl, acridinyl, anthracenyl, benzanthracenyls, benzimidazolyl, benzisoxazolyl, benzofluoranthenyls, benzofuranyl, benzoperylenyls, benzopyrenyls, benzothiazolyl, benzothiophenyls, benzoxazolyl, benzyl, carbazolyl, carbolinyl, chrysenyl, cinnolinyl, coronenyl, cyclohexyl, cyclohexenyl, methylcyclohexyl, dibenzoanthracenyls, fluoranthenyl, fluorenyl, furanyl, imidazolyl, indazolyl, indenopyrenyls, indolyl, indolinyl, isobenzofuranyl, isoindolyl, isoquinolinyl, isoxazolyl, methyl benzyl, methylphenyl, naphthyl, oxazolyl, phenanthrenyl, phenyl, purinyl, pyrazinyl, pyrazolyl, pyrenyl, pyridazinyl, pyridinyl, pyrimidinyl, pyrrolyl, quinazolinyl, quinolonyl, quinoxalinyl, thiazolyl, thiophenyl, and the like.

It is to be understood that for purposes herein, when a radical is listed, it indicates that the base structure of the radical (the radical type) and all other radicals formed when that radical is subjected to the substitutions defined above. Alkyl, alkenyl, and alkynyl radicals listed include all isomers including where appropriate cyclic isomers, for example, butyl includes n-butyl, 2-methylpropyl, 1-methylpropyl, tert-butyl, and cyclobutyl (and analogous substituted cyclopropyls); pentyl includes n-pentyl, cyclopentyl, 1-methylbutyl, 2-methylbutyl, 3-methylbutyl, 1-ethylpropyl, and nevopentyl (and analogous substituted cyclobutyls and cyclopropyls); butenyl includes E and Z forms of 1-butenyl, 2-butenyl, 3-butenyl, 1-methyl-1-propenyl, 1-methyl-2-propenyl, 2-methyl-1-propenyl, and 2-methyl-2-propenyl (and cyclobutenyls and cyclopropenyls). Cyclic compounds having substitutions include all isomer forms, for example, methylphenyl would include ortho-methylphenyl, meta-methylphenyl and para-methylphenyl; dimethylphenyl would include 2,3-dimethylphenyl, 2,4-dimethylphenyl, 2,5-dimethylphenyl, 2,6-diphenylmethyl, 3,4-dimethylphenyl, and 3,5-dimethylphenyl.

Likewise the terms “functional group”, “group” and “substituent” are also used interchangeably throughout this document unless otherwise specified. For purposes herein, a functional group includes both organic and inorganic radicals or moieties comprising elements from Groups 13, 14, 15, 16, 17 of the periodic table of elements. Suitable functional groups may include hydrocarbyl radicals, e.g., alkyl radicals, alkene radicals, aryl radicals, and/or halogen (Cl, Br, I, F), O, S, Se, Te, NR*ₓ, OR*, SeR*, TeR*, PR*ₓ, AsR*ₓ, SbR*ₓ, SR*, BR*ₓ, SiR*ₓ, GeR*ₓ, SnR*ₓ, PbR*ₓ, and/or the like, wherein R is a C₁ to C₂₀ hydrocarbyl as defined above and wherein x is the appropriate integer to provide an electron neutral moiety. Other examples of functional groups include those typically referred to as amines, imides, amides, ethers, alcohols (hydroxides), sulfides, sulfates, phosphides, halides, phosphonates, alkoxides, esters, carboxylates, aldehydes, and the like.

For purposes herein an “olefin,” alternatively referred to as “alkene,” is a linear, branched, or cyclic compound comprising carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer.

For purposes herein a “polymer” has two or more of the same or different “mer” units. A “homopolymer” is a polymer having mer units that are the same. A “copolymer” is a polymer having two or more mer units that are different from each other. A “terpolymer” is a polymer having three mer units that are different from each other. “Different” in reference to mer units indicates that the mer units differ from each other by at least one atom or are different isomerically. Accordingly, the definition of copolymer, as used herein, includes terpolymers and the like. An oligomer is typically a polymer having a low molecular weight, such an Mn of less than 25,000 g/mol, or in an embodiment less than 2,500 g/mol, or a low number of mer units, such as 75 mer units or less.

The terms “catalyst”, “catalyst compound” are defined to mean a compound capable of initiating polymerization, crosslinking, and/or curing of the reactive components to produce the cured thermoset material from the thermosetting resin under the appropriate conditions.

In embodiments, the monomers and/or the oligomers present in the thermosetting resin comprise linear and/or branched aliphatic moieties, linear and/or branched olefinic moieties, linear and/or branched moieties comprising alkyne functional groups, substituted or unsubstituted alicyclic moieties, substituted or unsubstituted aromatic moieties, substituted or unsubstituted heteroaromatic moieties, or combinations thereof.

In embodiments, the monomers and/or the oligomers may comprise C₁ to C₅ radicals, C₁ to C₁₀ radicals, C₁ to C₂₀ radicals, or C₆ to C₂₀ radicals, or C₇ to C₂₀ radicals that may be linear, branched, or cyclic where appropriate (aromatic or non-aromatic); and includes radicals substituted with other hydrocarbyl radicals and/or one or more functional groups comprising elements from Groups 13-17 of the periodic table of the elements. In addition two or more of the radicals and/or moieties may together form a fused ring system, including partially or fully hydrogenated fused ring systems, which may include heterocyclic radicals.

In embodiments an alkyl group may be a saturated linear or branched hydrocarbon groups including, for example, methyl, ethyl, isopropyl, t-butyl, heptyl, dodecyl, octadecyl, amyl, 2-ethylhexyl, and the like. In embodiments, an alkenyl group may be an unsaturated, linear or branched hydrocarbon group with one or more carbon-carbon double bonds, such as a vinyl group. In embodiments, an alkynyl group may be an unsaturated, linear or branched hydrocarbon group with one or more carbon-carbon triple bonds. Unless otherwise indicated, an aliphatic group typically contains from 1 to 30 carbon atoms. In embodiments, the aliphatic group may contain 1 to 20 carbon atoms, 1 to 10 carbon atoms, 1 to 6 carbon atoms, 1 to 4 carbon atoms, or 1 to 3 carbon atoms.

In embodiments, a urethane and/or urea-containing polymer may be a polymer that contains both urethane and urea groups as part of the polymer chain. A polyurethane/polyurea may be produced by the reaction of an isocyanate comprising at least two isocyanate groups per molecule with a compound having one or more terminal hydroxyl groups and a compound having one or more terminal amine groups. In embodiments, a polyurethane/polyurea may be produced by the reaction of an isocyanate containing at least two isocyanate groups per molecule with a compound having terminal hydroxyl groups and terminal amine groups (e.g., a hydroxyl-amine such as a hydroxyl alkyl amine, e.g., 3-hydroxy-n-butylamine (CAS 114963-62-1)). A reaction to form a polyurethane, a polyurea, and/or a polyurethane/polyurea may include other additives, including but not limited to, a catalyst, a chain extender, a curing agent, a surfactant, fillers; antioxidants (e.g., hindered phenolics such as IRGANOX 1010 or IRGANOX 1076 available from Ciba-Geigy); phosphites (e.g., IRGAFOS 168 available from Ciba-Geigy); anti-cling additives; tackifiers, such as polybutenes, terpene resins, aliphatic and aromatic hydrocarbon resins, alkali metal and glycerol stearates, hydrogenated rosins; UV stabilizers; heat stabilizers; anti-blocking agents; release agents; anti-static agents; pigments; colorants; dyes; waxes; silica; fillers; talc; and/or the like.

An isocyanate, which may be a polyisocyanate, comprises one or more moieties, according to the general formula R—(N═C═O)ₙ, where n may be at least 2, at least 3, at least 4, at least 5, at least 6, at least 7, or at least 8, wherein R is a C₁-C₂₀ aliphatic moiety, a C₃-C₂₀ alicyclic moiety, a C₂-C₂₀ olefinic moiety, a C₂-C₂₀ alkynal moiety, a C₆-C₂₀ aromatic moiety, a C₅-C₂₀ heteroaromatic moiety, or a combination thereof. In embodiments, an isocyanate may have an n that is equivalent to n in methylene diphenyl diisocyanate (MDI). In embodiments, the isocyanate may be a di-isocyanate (e.g., R—(N═C═O)₂ or (O═C═N)—R—(N═C═O)).

Examples of suitable isocyanates include, but are not limited to, methylene diphenyl diisocyanate (MDI) and toluene diisocyanate (TDI). Examples of MDI may include, but are not limited to, monomeric MDI, polymeric MDI, and isomers thereof. Examples of isomers of MDI having the chemical formula C₁₅H₁₀N₂O₂ may include, but are not limited to, 2,2′-MDI, 2,4′-MDI, and 4,4′-MDI. Examples of isomers of TDI having the chemical formula C₉H₆N₂O₂ may include, but are not limited to, 2,4-TDI and 2,6-TDI. In embodiments, examples of isocyanates may include, but are not limited to, monomeric diisocyanates and block polyisocyanates. In embodiments, examples of monomeric diisocyanates may include, but are not limited to, hexamethylene diisocyanate (HDI), methylene dicyclohexyl diisocyanate or hydrogenated MDI (HMDI), and isophorone diisocyanate (IPDI). In embodiments, an example of an HDI may be hexamethylene-1,6-diisocyanate. In embodiments, an example of an HMDI may be dicyclohexylmethane-4,4′-diisocyanate. Blocked polyisocyanates may be based on HDI or IDPI. In embodiments, examples of blocked polyisocyanates may include, but are not limited to, HDI trimer, HDI biuret, HDI uretidione, and IPDI trimer.

In embodiments, examples of isocyanates may include, but are not limited to, aromatic diisocyanates, such as a mixture of 2,4- and 2,6-tolylene diisocyanates (TDI), diphenylmethane-4,4′-diisocyanate (MDI), naphthalene-1,5-diisocyanate (NDI), 3,3′-dimethyl-4,4′-biphenylene diisocyanate (TODI), crude TDI, polymethylenepolyphenyl isocyanurate, crude MDI, xylylene diisocyanate (XDI), and phenylene diisocyanate; aliphatic diisocyanates, such as 4,4′-methylene-biscyclohexyl diisocyanate (hydrogenated MDI), hexamethylene diisocyanate (HMDI), isophorone diisocyanate (IPDI), and cyclohexane diisocyanate (hydrogenated XDI); and modified products thereof, such as isocyanurates, carbodiimides and allophanamides.

In embodiments, a compound having terminal hydroxyl groups (R—(OH)ₙ), where n is at least 2 (referred to herein as “di-functional”), at least 3 (referred to herein as “tri-functional”), at least 4, at least 5, at least 6, at least 7, at least 8, at least 9, and 10, wherein R is a C₁-C₂₀ aliphatic moiety, a C₃-C₂₀ alicyclic moiety, a C₂-C₂₀ olefinic moiety, a C₂-C₂₀ alkynal moiety, a C₆-C₂₀ aromatic moiety, a C₅-C₂₀ heteroaromatic moiety, or a combination thereof.

In embodiments, a polyol mixture may include a small amount of mono-functional compounds having a single terminal hydroxyl group.

In embodiments, suitable examples of polyols include, but are not limited to, polyester polyols and polyether polyols. In embodiments, examples of polyester polyols may include, but are not limited to, those produced from condensation of acids and alcohols. In embodiments, examples may include those built from phthalic anhydride and diethylene glycol, phthalic anhydride and dipropylene glycol, adipic acid and butanediol, and succinic acid and butane or hexanediol. In embodiments, polyester polyols may be semi-crystalline. In embodiments, examples of polyether polyols may include, but are not limited to, those built from polymerization of an oxide such as ethylene oxide, propylene oxide, or butylene oxide from an initiator such as glycerol, dipropylene glycol, TPG (tripropylene glycol), castor oil, sucrose, sorbitol, and/or the like.

In embodiments, examples of polyols may include, but are not limited to, polycarbonate polyols and lactone polyols such as polycaprolactone. In embodiments, a compound having terminal hydroxyl groups (R—(OH)ₙ) may have a molecular weight (calculated before incorporation of the compound having terminal hydroxyl groups into a polymer) of from about 200 g/mol weight average molecular weight, to about 20,000 g/mol, such as from about 200 g/mol to about 10,000 g/mol (Mw).

In embodiments, a reactive compound may comprise a terminal amine groups (e.g., R—(N(R′)₂)ₙ), where n may be at least 2, at least 3, at least 4, at least 5, at least 6, at least 7, at least 8, at least 9, and 10, wherein R is a C₁-C₂₀ aliphatic moiety, a C₃-C₂₀ alicyclic moiety, a C₂-C₂₀ olefinic moiety, a C₂-C₂₀ alkynal moiety, a C₆-C₂₀ aromatic moiety, a C₅-C₂₀ heteroaromatic moiety, or a combination thereof, which is referred to herein as a “polyamine.” In embodiments, a polyamine mixture may include a small amount of mono-functional compounds having a single terminal amine functional group.

In embodiments, a suitable polyamine may be a diamine or triamine, and may be either a primary or secondary amine. In embodiments, a compound having terminal amine groups may have a molecular weight (calculated before incorporation of the compound having terminal hydroxyl groups into a polymer) of from about 31 g/mol to about 5001 g/mol, such as from about 41 g/mol to about 401 g/mol.

In embodiments, suitable examples of polyamines include, but are not limited to, diethyltoluene diamine, di-(methylthio)toluene diamine, 4,4′-methylenebis(2-chloroaniline), and chain extenders available under the trade names LONZACURE L15, LONZACURE M-CDEA, LONZACURE M-DEA, LONZACURE M-DIPA, LONZACURE M-MIPA, and LONZACURE DETDA (lonza.com, Allendale N.J.).

In embodiments, examples of suitable polyamines may include, but are not limited to, ethylene diamine, 1,2-diaminopropane, 1,4-diaminobutane, 1,3-diaminopentane, 1,6-diaminohexane, 2,5-diamino-2,5-dimethylhexane, 2,2,4- and/or 2,4,4-trimethyl-1,6-diaminohexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′ and/or 4,4′-diaminodicyclohexyl methane, and 3,3′-dialkyl-4,4′-diamino-dicyclohexyl methanes such as 3,3′-dimethyl-4,4-diamino-dicyclohexyl methane and 3,3′-diethyl-4,4′-diaminodicyclohexyl methane; aromatic polyamines such as 2,4- and/or 2,6-diaminotoluene and 2,4′ and/or 4,4′-diaminodiphenyl methane; and polyoxyalkylene polyamines.

In embodiments, the term polyol and/or polyamine mixture may comprise one or more polyols of varied molecular weights and functionalities, one or more polyamines of varied molecular weights and functionalities, or a combination of one or more polyols and one or more polyamines.

In embodiments, the thermosetting resin may comprise at least one reactive component. In embodiments, the thermosetting resin may comprise at least two reactive components. In embodiments, the thermosetting resin may comprise at least three reactive components. In embodiments, the thermosetting resin may comprise at least four reactive components.

In embodiments, the thermosetting resin may be prepared by methods disclosed in WO 2018/106822 and PCT/US2018/064323, each of which is incorporated in its entirety herein. In embodiments, a method for making a thermosetting resin, such as a urethane and/or urea-containing polymer thermoset product, may include introducing first and second reactive components into a mixing chamber. In embodiments, the first reactive component may include an isocyanate and the second reactive component may include a polyol and/or polyamine mixture. In embodiments, the first reactive component may include an isocyanate and the second reactive component may include a polyol. In embodiments, the first reactive component may include an isocyanate and the second reactive component may include a polyamine. In embodiments, the first reactive component may include an isocyanate and the second reactive component may include a polyol and a polyamine. The first and second reactive components may have certain characteristics including, but not limited to, viscosity, reactivity, and chemical compatibility.

In embodiments, the thermosetting resin may cure to form a solid (or essentially solid) thermoset material. In embodiments, the thermosetting resin may cure to form a foam i.e., a foamed thermoset material.

In embodiments, the 3D object and/or one or more of the deposited layers and/or one or more portions of a deposited layer of the thermosetting resin may cure to form a solid (or essentially solid) thermoset material and a foamed thermoset material.

While the following description is in the context of foams, the description may apply to thermosetting resins, including urethane and/or urea-containing polymers in general, both non-foam and foam. Foams are available in a range of hardness and resiliencies. A urethane and/or urea-containing polymer may be very durable, permitting the foam to be used repeatedly without a change in properties. This range of properties permits these materials to be used in clinical settings where rigid positioning is desirable or where pressure distribution is more desirable.

Foams of urethane and/or urea-containing polymers may be the product of a reaction between two reactant components. A range of foam properties may be achieved by altering the relative weights of formulation components to balance reaction speed, interfacial tension of the reacting mixture, and elasticity of the polymeric scaffold. In 3D printing, an extrusion nozzle may deposit material, e.g., thermosetting resin, on a substrate layer by layer, following a 3D computer model of the desired 3D object.

In embodiments, foam precursor formulas may enable high resolution 3D deposition to form a custom 3D foam object. In embodiments, by partially advancing the reaction of the precursors, such as polyurethane precursors, and adjusting catalyst and surfactant levels, it is possible to deposit the thermosetting resin while maintaining the desired predetermined part resolution and mechanical integrity of the foam.

The production of a foam of urethane and/or urea-containing polymers may differ from the production of a non-foam urethane and/or urea-containing polymer by the inclusion of water or another foam forming component or blowing agent. Foams of urethane and/or urea-containing polymer may be formed by the simultaneous reaction of isocyanates with water to form urea linkages and produce gas, and the reaction of isocyanates with multifunctional high molecular weight alcohols to form a crosslinked elastomeric foam scaffold.

In embodiments, foams may be formed by reacting monomers: a di-isocyanate, water, and multi-functional alcohol (e.g., a polyol) or a multi-functional amine. The quantity of water in the formula may affect the foam density and the strength of the foam scaffold. The molecular weight of the polyol and/or polyamine mixture may determine the crosslink density of the foam scaffold and the resulting elasticity, resiliency, and hardness of the foam. In embodiments, a nearly stoichiometric quantity of di-isocyanate may be used to fully react with the water and a polyol and/or polyamine mixture.

In embodiments, prepolymer synthesis may be used to alter the cure profile of a polyurethane or polyurea system. In prepolymer synthesis, a stoichiometric excess of di-isocyanate may be reacted with a polyol and/or polyamine mixture. The resulting prepolymer may have a higher molecular weight than the starting di-isocyanate, and molecules in the pre-polymer may have isocyanate functionality and therefore still be reactive. Because of the higher molecular weight, hydrogen bonding, and/or urea linkages, the prepolymer may also have a higher viscosity. This prepolymer may be subsequently reacted with a polyol and/or polyamine mixture and water to produce a foam with substantially the same foam scaffold composition that is achievable without prepolymer synthesis. However, viscosity growth profile may be altered, typically starting higher, and increasing more slowly, and therefore the morphological features of the foam, such as foam cell size and cell stability, may result in a foam with a very different appearance.

Support foams are not a single density, hardness, or resilience, but may span a wide range of performance. The present disclosure extends the entire range of foam properties. Foam density and hardness may be interrelated: low density foams may be softer foams. A range of foam density and hardness may be achieved first by varying the level of blowing agent, such as water, in the formulation and by adjusting the extent of excess isocyanate in the formula. Increasing the degree of functionality of the components of the polyol and/or polyamine mixture (e.g., incorporating some 4- or 6-functional polyols) may increase hardness and the viscosity growth rate during cure. Foam resilience may be altered by varying the polyols and/or polyamines incorporated in the formula. Memory foams may be achieved by reducing the molecular weight of the polyols and polyamines; high resiliency may be achieved by incorporating graft polyols. In embodiments, the foam density range may be less than 0.3 g/cm³, ranging from 30-50 ILFD hardness, and resilience ranging from 10 to 50%. Foam properties may also include open cell content and closed cell content. Open cell foams may be cellular structures built from struts, with windows in the cell walls which may permit flow of air or liquid between cells. Closed cells may be advantageous for preventing air flow, such as in insulation applications.

### Controller, Sensors, and Processors

In embodiments, the present disclosure includes a control system or a computing apparatus operably coupled to a printing apparatus.

The computing apparatus may be, for example, any fixed or mobile computer system (e.g., a controller, a microcontroller, a personal computer, minicomputer, etc.). The exact configuration of the computing apparatus is not limiting, and essentially any device capable of providing suitable computing capabilities and control capabilities may be used, a digital file may be any medium (e.g., volatile or non-volatile memory, a CD-ROM, magnetic recordable tape, etc.) containing digital bits (e.g., encoded in binary, etc.) that may be readable and/or writeable by computing apparatus. Also, a file in user-readable format may be any representation of data (e.g., ASCII text, binary numbers, hexadecimal numbers, decimal numbers, graphically, etc.) presentable on any medium (e.g., paper, a display, etc.) readable and/or understandable by an operator.

In embodiments, the control system may include one or more processors.

In embodiments, the controller may comprise one or more processors and may provide instructions to the extruded thermoset printing apparatus. These instructions may modify the process for printing a 3D printed object. In embodiments, these instructions instruct at least one actuator operably coupled to the extrusion nozzle to move the extrusion nozzle when delivering thermosetting resin to form the 3D printed object.

In embodiments, 3D Printing system may be fully controlled by G-code commands. The system/firmware may have a web control or internet interface, and all G-code commands may be sent via http string. This includes the motion of printer head and printing control (e.g., extrusion, environment configurations). Scanning processes may be inserted as a comment, and the system may be halted until the process is completed.

In embodiments, a controller may analyze aspect ratio and deposit thermosetting resin based on the aspect ratio of a bead. For example, the controller may instruct the 3D printer to print with a low aspect ratio/high viscosity bead for certain aspects of a 3D printed object and then the controller may instruct the 3D printer to print with a high aspect ratio/low viscosity bead for other aspects of a 3D printed object. This controlling of aspect ratio may provide a 3D printed object with high resolution, e.g., on the edges of a 3D object, and then use increased printing speeds to space fill aspects of a 3D object.

In embodiments, the controller may adjust one or both of the amount and flow rate of the thermosetting resin to provide a physical property of a first area that is different than the same physical property of the second area. In embodiments, the physical property may be one or more of flexibility, color, optical refractive index, hardness, porosity, and density.

In embodiments, the controller may be configured to execute or the process further comprises adjusting one or both of an amount and a flow rate of a gas-generation source for use with one or more of a first, second, and third reactive components.

In embodiments, the controller may be configured to execute or the process further comprises controlling a distance between the extrusion nozzle and the 3D printed object.

In embodiments, the predefined design comprises one or more necessary attributes and one or more optional attributes. In such embodiments, these attributes are akin to tolerances. In such embodiments, the depositing of the subsequent one or more layers of thermosetting resin according to one or more adjusted deposition parameters forms a 3D object comprising optional attributes which differs from the predefined design, but which comprises all of the necessary attributes of the predefined design. In other words, the depositing of the subsequent one or more layers of thermosetting resin according to one or more adjusted deposition parameters are directed to achieving a necessary attribute or tolerance, at the expense of an optional or non-essential attribute or tolerance of the final 3D object according to an intended purpose.

In one of such embodiments, the perturbation profile includes information directed to a height of the deposited layers of the thermosetting resin, and wherein the adjusting of the one or more deposition parameters of one or more subsequent layers based the perturbation profile results in a 3D object comprising at least one portion that differs in a total height from the predefined design by a distance of less than or equal to about a height of one of the deposited layers. Accordingly, if a necessary attribute is a particular shape or profile of a surface of the final 3D object and an optional attribute is a total height of the 3D object within a particular range, in embodiments the adjusted depositing of the subsequent one or more layers of thermosetting resin according to the adjusted deposition parameters forms the 3D object according to the necessary attributes of the predefined design in contrast to a an absolute value predicted by the predefined design with respect to the optional or non-essential attributes. This may be in terms of the final 3D object produced by the process, or may be based on one or more layers according to the predefined design.

In some embodiments, the perturbation profile may be determined from a visual scanner which is then utilized to instruct the printer to add material to specific (X, Y) locations wherein X-Y refers to the horizontal plane. A line scanner may be used to scan the surface of an object. The scan data includes Z-height values for a grid of locations above the object, wherein the Z-height refers to the vertical dimension. These data were then loaded into a controller system tool comprising an algorithm configured to allow the user to specify threshold boundaries in the X, Y, and Z dimensions and to restrict the region to be addressed. Within this selected region, the controller is configured to acquire the scan data comprising the actual Z-height for a plurality of X-Y locations along the desired Z-Height specified by the user, and to compute the volume of space that is required to be filled such that the Z-height at the specific X-Y location is raised to the desired Z-Height. In such an embodiment, the calculated or determined volume is multiplied by the volumetric density of the extruded material (computed and/or measured) to compute the necessary G-Code, E-Value parameter that must be sent to the extruder. The deposition path may then be determined according to the required deposition parameters and configured to minimize starts and stops.

To achieve this, a plurality of continuous deposition paths may be generated for each unbroken region that requires additional material, therefore reducing the number of starts and stops to be equal to the number of disconnected regions in need of additional material relative to the predefined design.

The adjusted or modified deposition path determined to fill a region is then generated using a flood-fill algorithm with the extrusion used on each motion calculated from the volume x density measurement as described above. The user may be given the option to prioritize eight directions in the flood fill algorithm (N, NE, E, SE, S, SW, W, NW) and chosen between recursive and loop-wise flood-fill algorithms. These choices will yield different paths to cover a region which the user may deem more optimal.

The data gathered by the laser line scanner and subsequent G-Code generated by the tool is based on the exact coordinates of the object when it is scanned. Therefore, it was obvious that the object must be in the same exact location when the G-Code is applied for proper void filling to occur. If the object has moved by a known distance and/or rotated by a known angle relative to the original position it was during the initial scanning, a translation and rotation tool may be employed from commercially available software which applies the known translation and rotations to the G-Code coordinates to produce new G-Code which is oriented correctly for the new location of the object. The end result is an ability to fill voids in an object that occur during the printing.

In such an embodiment, a laser scanner line scanner may be mounted on the 3D printer gantry. As the gantry moves around the X-Y plane, the scanner moves along with it to collect Z-height data to of a grid of X-Y locations.

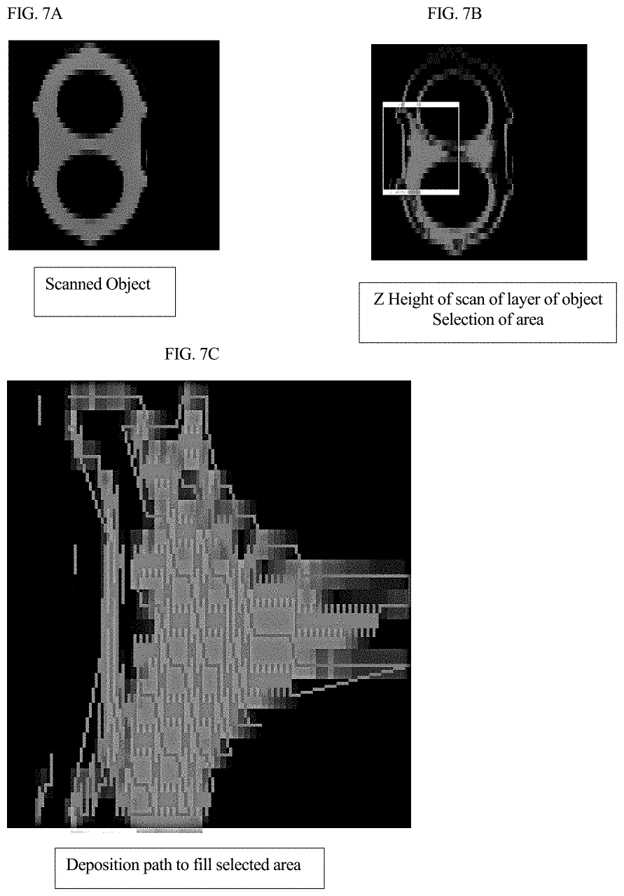

The scanned data included the Z-height information for the part that has been scanned. The Z-height information was encoded into the color of the location. After XY bounds and Z height restrictions were specified by the user, the parts of the object that are below the specified optimal Z-height remain colored. To address the voids present in the region, the tool was employed to generate a path to traverse the region and deposit additional material. The extrusion tip was instructed to follow this modified deposition path as it deposits various extrusion amounts based on the volume of the void at a particular X-Y location. An example of the results of this process is shown in FIGS. 7A-7C.

In other embodiments, a scan-to-print tool is utilized to provide the capability to print on a designated object or on a non-planar surface. The tool may be integrated or configured to utilize a laser profile scanner with a 3D printer system, or the like. In embodiments, the scanner is attached to the printer head. The position offset by a known amount in the X and Y directions. The position difference between printer tip and scanner is calibrated such that the output of the scan is in the coordinate of the printer tip. The laser line is along the X direction. The scan direction is along with the Y axis. The user can specify the step size for each y step. Depending on the height of the scanned object, the width of the laser profile beam is within a particular distance, e.g., between about 80 mm to 100 mm. In embodiments, an additional scanning step in the X direction may be added if the scanned object is wider than the laser line width. The final scan result are then combined.

The scan data consist of z height measurements in a grid of X and Y positions. The scan-to-print tool may optionally allow a user to define the scanning area and to adjust the G-code position and/or orientation (translation and rotation transformation of G-code). The tool then provides the visualization for the overlapping of G-code and scanning results.

In another embodiment, the scanning may utilize a Scan to Print Tool, to print on a designated object and non-planar printing. In such an embodiment, a laser scanner is attached to the printer gantry at a known distance from the extrusion nozzle. The laser profile scanner (e.g., a micro-epsilon LLT2900-100/BL) may be used to scan an object to determine the object position (X and Y position) and surface topography (Z height) using commercially available software. After the scan, 2D topography data is generated, presented, and saved. The tool is then uploaded with G-code of the printing object using the scan-to print tool. The G-code instructions for the printing path were generated from a slicer (Simplify 3D) common in the art. The software provides the visualization of the overlapping.

In embodiments, the user is allowed to align the designed G-code position to the actual scanning image. The G-code is then re-generated for the new location and orientation, and is used for executing print commands. The alignment included translation and rotation in X-Y plane and variation in Z direction. Once the G-code is aligned, these data are saved and submitted to the printer to print using commercially available software.

In another embodiment, the G-code is generated on-the-fly from the scanning result to perform non-planar printing. In such an embodiment, a scanner is used to scan an object to determine the object's position and surface topography. In embodiments, the tool is configured to allows a user to set up z threshold to detect the object's outline.

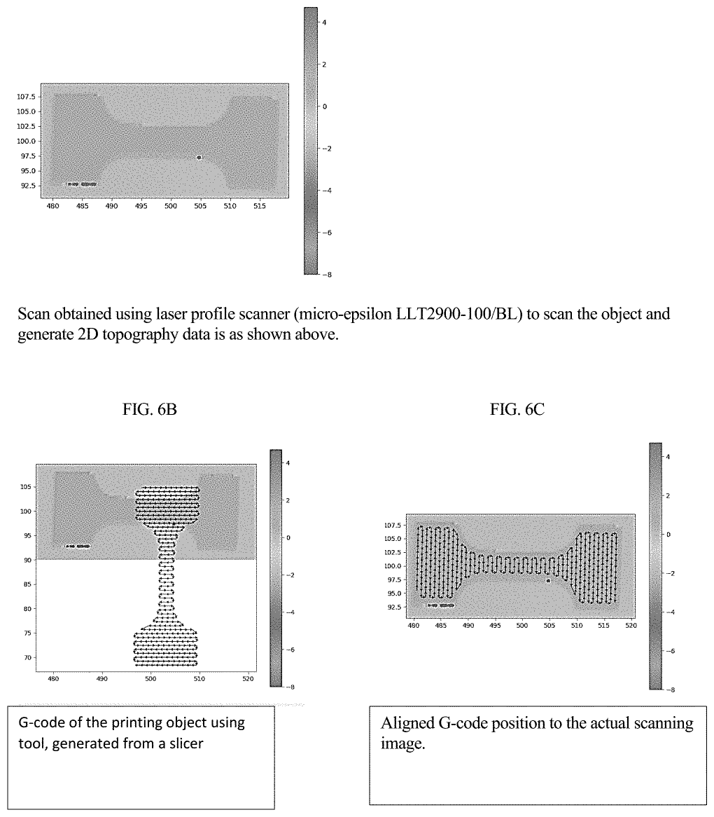

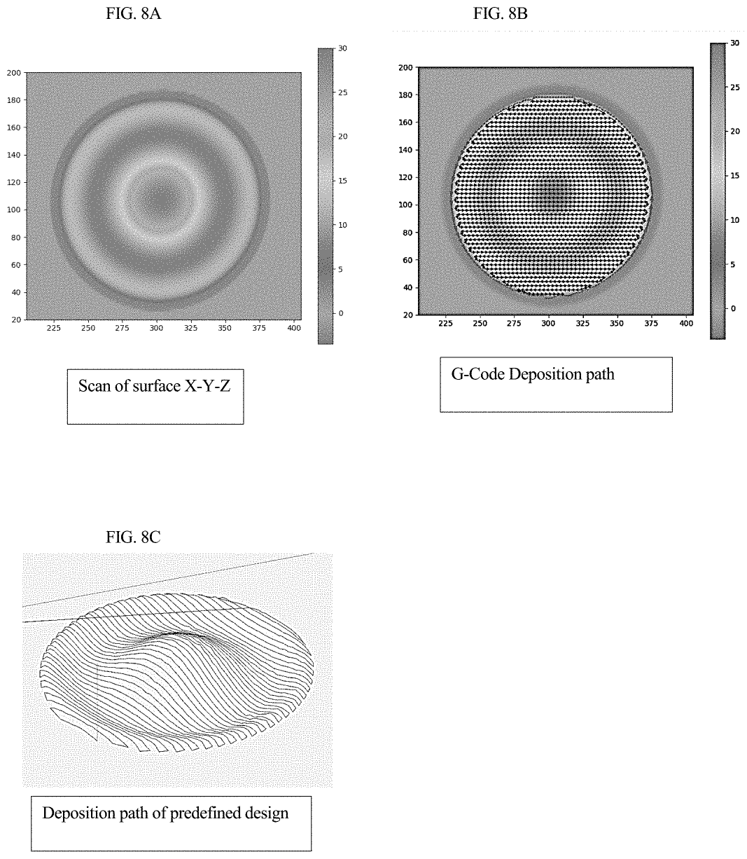

The G-code is generated to fill the area defined by the outline. The generated G-code Z-height is configured to follow the scanned topography to maintain proper spacing between printing tip and print-on the non-planar surface. The tool is configured to allow the user to configure the bead spacing, extrusion rate, tip height, printing speed and the X-Y resolution for Z corrections. The required G-code is determined, saved, and submitted to the printer system to print the 3D object. Examples of the results of this process are shown in FIGS. 6A-C and FIGS. 8A-C.

### Embodiments Listing

Embodiments according to the instant disclosure include:
E1. A three-dimensional (3D) object production process comprising:
   a) providing a thermoset printing apparatus comprising:
   a mixing chamber into which a plurality of components comprising a first reactive component and a second reactive component are directed and contacted to produce an extrudable thermosetting resin;
   an extrusion nozzle in fluid communication with the mixing chamber through which the thermosetting resin is extruded and deposited onto a substrate or at least a portion of another deposited layer of the thermosetting resin;
   at least one actuator coupled to the extrusion nozzle configured to move the extrusion nozzle;
   a controller coupled to the thermoset printing apparatus configured to produce the thermosetting resin and direct the deposition of the thermosetting resin from the extrusion nozzle along a deposition path according to one or more deposition parameters to form the 3D object according to a predefined design; and
   a scanner coupled to the thermoset printing apparatus;
   b) depositing the thermosetting resin along the deposition path during at least a portion of which the thermosetting resin is produced and deposited according to the one or more deposition parameters to form one or more layers of the thermosetting resin according to the predefined design;
   c) scanning at least a portion of the one or more of the deposited layers of the thermosetting resin to detect one or more perturbations present therein, which differ from the predefined design to form a perturbation profile;
   d) adjusting the one or more deposition parameters of one or more subsequent layers based the perturbation profile; and
   e) depositing the subsequent one or more layers of thermosetting resin according to the adjusted deposition parameters to form the 3D object according to the predefined design.
E2. The process according to embodiment E1, wherein the scanner comprises an optical scanner, a laser scanner, a profile sensor, a point laser sensor, a confocal displacement sensor, an X-ray scanner, a high speed area camera, a line scan camera, or a combination thereof.
E3. The process according to embodiment E1 or E2, wherein at least a portion of the scanning is conducted separately from the depositing of the thermosetting resin along the deposition path;
   wherein at least a portion of the scanning is conducted during the depositing of the thermosetting resin along the deposition path; or a combination thereof.
E4. The process according to any one of embodiments E1 through E3, wherein the perturbation profile comprises each perturbation detected in the one or more layers of the thermosetting resin.
E5. The process according to any one of embodiments E1 through E4, wherein the perturbation profile comprises each perturbation detected in one or more portions of the one or more layers of the thermosetting resin.
E6. The process according to any one of embodiments E1 through E5, wherein the perturbation profile comprises an average of each perturbation detected in the one or more layers of the thermosetting resin.
E7. The process according to any one of embodiments E1 through E6, wherein the perturbation profile comprises an average of each perturbation detected in one or more portions of the one or more layers of the thermosetting resin;
E8. The process according to any one of embodiments E1 through E7, wherein the adjusting of one or more deposition parameters includes adjustments to the deposition path.
E9. The process according to any one of embodiments E1 through E8, wherein the adjusting of one or more deposition parameters includes adjustments of a bead spacing at which the thermosetting resin is deposited onto a substrate or at least a portion of another layer.
E10. The process according to any one of embodiments E1 through E9, wherein the adjusting of one or more deposition parameters includes adjustments of a tip height determined as a distance of the extrusion nozzle above the layer, and/or substrate on which the thermosetting resin is deposited during at least a portion of the deposition path.
E11. The process according to embodiment E10, wherein the adjusting of one or more deposition parameters includes wherein the tip height is adjusted partially based on measured height of a deposited layer provided by the scanner to prevent accumulation of the thermosetting resin on the extrusion nozzle.
E12. The process according to embodiment E10 or E11, wherein the adjusting of one or more deposition parameters includes wherein the tip height is adjusted partially based on measured height of a deposited layer provided by the scanner to prevent contact of the extrusion nozzle with the deposited layer of thermosetting resin.
E13. The process according to any one of embodiments E1 through E12, wherein the adjusting of one or more deposition parameters includes adjustments of an extrusion percent at which the thermosetting resin is extruded during at least a portion of the deposition path based on a total amount of the thermosetting resin predicted to be required during the portion of the deposition path according to the predefined design.
E14. The process according to any one of embodiments E1 through E13, wherein the adjusting of one or more deposition parameters includes adjustments of a flow rate of the thermosetting resin through the extrusion nozzle during at least portion of the deposition path.
E15. The process according to any one of embodiments E1 through E14, wherein the adjusting of one or more deposition parameters includes adjustments of a pumping pressure applied to the thermosetting resin within the extrusion nozzle during at least portion of the deposition path.
E16. The process according to embodiment E15, wherein the pumping pressure applied to the thermosetting resin within the extrusion nozzle during at least portion of the deposition path is reduced or negative in an amount sufficient to prevent flow of the thermosetting resin through the extrusion nozzle during the portion of the deposition path.
E17. The process according to any one of embodiments E1 through E16, wherein the adjusting of one or more deposition parameters includes adjustments of a translation speed of the extrusion nozzle along at least a portion of the deposition path.
E18. The process according to any one of embodiments E1 through E17, wherein the adjusting of one or more deposition parameters includes adjustments of a composition of the thermosetting resin being deposited.
E19. The process according to embodiment E18, wherein the adjusting of the composition of the thermosetting resin being deposited includes adjusting a residence time and/or a temperature of the plurality of components within the mixing chamber.
E20. The process according to embodiments E18 or E19, wherein the adjustment of the composition of the thermosetting resin comprises increasing an amount of one or more of the plurality of components into the mixing chamber relative to at least one other component.
E21. The process according to any one of embodiments E18 through E20, wherein the adjustment of the composition of the thermosetting resin comprises directing at least one additional component into the mixing chamber, and/or ceasing the directing of at least one of the components being directed into the mixing chamber.
E22. The process according to any one of embodiments E18 through E21, wherein the adjustment of the composition of the thermosetting resin comprises directing at least a third reactive component into the mixing chamber.
E23. The process according to any one of embodiments E18 through E22, wherein the adjustment of the composition of the thermosetting resin comprises directing one or more components into the mixing chamber effective to change a cure rate of the thermosetting resin being deposited.
E24. The process according to any one of embodiments E18 through E23, wherein the adjustment of the composition of the thermosetting resin is effective to change a viscosity of the thermosetting resin being deposited.
E25. The process according to embodiment E24, wherein the adjustment of the composition of the thermosetting resin effective to change a viscosity of the thermosetting resin being deposited comprises beginning the directing one or more other components into the mixing chamber.
E26. The process according to embodiment E24 or E25, wherein the adjustment of the composition of the thermosetting resin effective to change a viscosity of the thermosetting resin being deposited comprises increasing and/or decreasing an amount of one or more of the plurality of components being directed into the mixing chamber relative to another component.
E27. The process according to any one of embodiments E24 through E26, wherein the adjustment of the composition of the thermosetting resin effective to change a viscosity of the thermosetting resin being deposited comprises stopping the directing of one or more components into the mixing chamber.
E28. The process according to any one of embodiments E24 through E27, wherein the adjustment of the composition of the thermosetting resin effective to change a viscosity of the thermosetting resin being deposited comprises adjusting a residence time of the plurality of components within the mixing chamber.
E29. The process according to any one of embodiments E24 through E28, wherein the adjustment of the composition of the thermosetting resin effective to change a viscosity of the thermosetting resin being deposited comprises adjusting a temperature of the plurality of components within the mixing chamber.
E30. The process according to any one of embodiments E18 through E29, wherein the adjustment of the composition of the thermosetting resin is effective to change a viscoelasticity of the thermosetting resin being deposited.
E31. The process according to any one of embodiments E1 through E30, wherein the predefined design comprises one or more necessary attributes and one or more optional attributes, and wherein the depositing of the subsequent one or more layers of thermosetting resin according to the adjusted deposition parameters forms a 3D object comprising optional attributes which differs from the predefined design, and which comprises all of the necessary attributes of the predefined design.
E32. The process according to any one of embodiments E1 through E31, wherein the perturbation profile includes information directed to a height of the deposited layers of the thermosetting resin, and wherein the adjusting of the one or more deposition parameters of one or more subsequent layers based the perturbation profile results in a 3D object comprising at least one portion that differs in a total height from the predefined design by a distance of less than or equal to about a height of one of the deposited layers.
E33. A 3D object produced according to the process of any one of embodiments E1 through E32.
E34. A 3D object printing system configured according to the process of any one of embodiments E1 through E32.

### EXAMPLES

The processes, systems, and objects described herein are now further detailed with reference to the following examples. These examples are provided for the purpose of illustration only and the embodiments described herein should in no way be construed as being limited to these examples. Rather, the embodiments should be construed to encompass any and all variations which become evident as a result of the teaching provided herein.

### Example 1: Printing of 3D Object

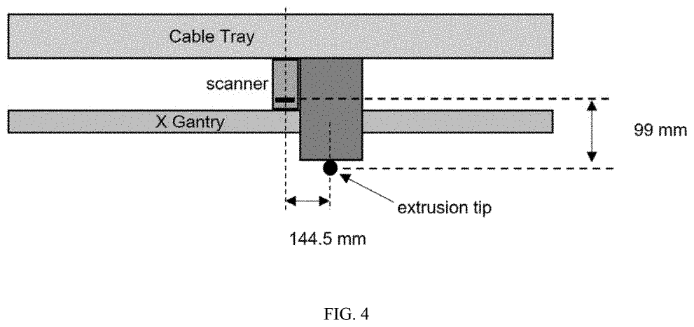

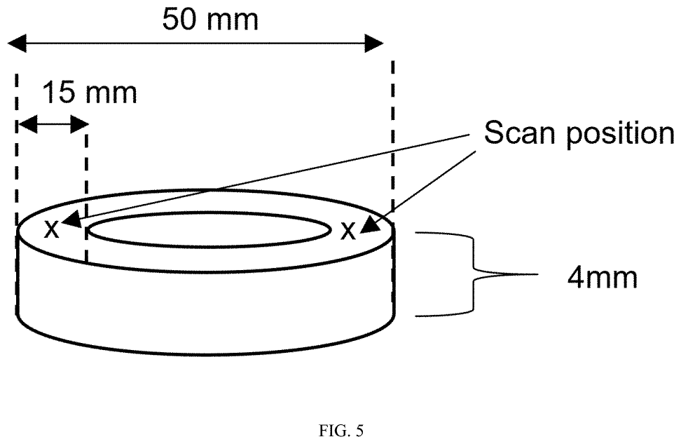

A Micro-Epsilon laser profile scanner (scanConTROL 2900 BL100) was installed in JuggerBot 3D printer (FIG. 4). The scanner was affixed to the printer head. The distance between the center of the scanner and the printing tip was 144.5 mm in x-axis and −99 mm in y-axis. The scanner, printer control (Duet System), and control PC were connected to an internal internet switch. The process was as follows:

Processed G-code by inserting scanning commands. Inserted commands containing scan position and expected height in G-code to indicate where to scan.

a. The object was a ring-type object with a 15 mm thickness and a 4 mm height printed with 4 layers. Each layer was 1 mm in height. Two positions for scanning were selected (shown in FIG. 4).
b. After printing each layer, the system scanned the two positions to determine the actual printed height by taking the average of two measurements.
i. The measurement at one position was 1.07 mm and the other position was 1.03 mm, so an average of 1.05 mm was used as the final measured result.
c. The software compared the measurement with expected height and sent stepping commands to maintain the proper spacing between the printing tip and the printing surface.
i. The expected height for the layer was 1.0 mm and the measurement was 1.05 mm. The system implemented a stepping command of 0.05 mm (moved the printing bed 0.05 mm downward but kept same printing coordinate).
d. After the adjustment, the system resumed the printing for the next layer.
e. Step b, c, and d were repeated until the print was finished.
Running the software during the printing:
f. The software uploaded the G-code to Duet system for the printing process.
g. The software checked scanning positions/layer information from the G-code.
h. The software started the printing process.
i. The software started monitoring the printing process for the signal of scanning.
j. Once the software detected the scanning signal (Duet system halted the printing and lift up tip height 10 mm higher than the expected height), it issued Duet commands to move the scanning position and issued scanning commands to the scanner to acquire data.
k. The software process data (details described in the next section) and determine the z height adjustment and issue baby stepping command to Duet.
l. The software resumes the printing process. Step b to step f will be repeated until the whole print is finished.

Alternative Scanning Data Processing: The ring-type object was also scanned using a Micro-Epsilon Profile scanner, which gave 1280 data points in each profile (around 110 mm wide, the width varies based on scanning height). The raw data from sensor was processed in the following steps. The process aimed at removing any irregular scattering signals due to dust particles, surface roughness, or other sources of optical noise.

a. Rejected abnormal data point. Filtered out data points outside a logical range (−10-110 mm). The rejected points were replaced by fitting 5 neighboring points (before and after the rejecting region).
b. Data Smooth. The data were smoothed by a second order polynomial fit from neighbor points. The return scan profile was based on the fitting.
c. Applied the calibration and bed topology. The calibration of sensor leveling and bed topology were applied for each given position.

Calibration. The sensor calibration contained of two parts. The first was the bed topology measurement and the second part was the sensor leveling calibration.

a. Bed topology measurement. Performed measurement over the printable area on the printing bed. The software (user) setup a grid of points on the bed and measured the height of each point. The height of each point was determined from the center value of the fitting of 1280 points. The measured height of all points was fitted with a 2D polynomial function. The fitted parameters were stored in a xml configuration file and were applied automatically when software returned the scanning result.

Sensor leveling calibration. The sensor was mounted in the orientation that the profile is along the x-axis. To determine the tilt of the sensor, a calibration process was done by scanning 10 points along the profile range (100 mm). The measured value was only from the center of the fitted profile. The 10 points were fitted and compared with a single scan profile which covered the same range. The difference along the profile was be fitted with a second order polynomial function. The fitted parameters were stored in the xml configuration file and applied automatically for each scan.

The foregoing disclosure and description of the invention is illustrative and explanatory thereof and it can be readily appreciated by those skilled in the art that various changes in the size, shape and materials, as well as in the details of the illustrated construction or combinations of the elements described herein can be made without departing from the spirit of the invention. Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

We claim:

1. A three-dimensional (3D) object production process comprising:
a) providing a thermoset printing apparatus comprising:
a mixing chamber into which a plurality of components comprising a first reactive component and a second reactive component are directed and contacted to produce an extrudable thermosetting resin;
an extrusion nozzle in fluid communication with the mixing chamber through which the thermosetting resin is extruded and deposited onto a substrate or at least a portion of another deposited layer of the thermosetting resin;
at least one actuator coupled to the extrusion nozzle configured to move the extrusion nozzle;
a controller coupled to the thermoset printing apparatus configured to produce the thermosetting resin and direct the deposition of the thermosetting resin from the extrusion nozzle along a deposition path according to one or more deposition parameters to form the 3D object according to a predefined design; and
a scanner coupled to the thermoset printing apparatus;
b) depositing the thermosetting resin along the deposition path during at least a portion of which the thermosetting resin is produced and deposited according to the one or more deposition parameters to form one or more layers of the thermosetting resin according to the predefined design;
c) scanning at least a portion of the one or more of the deposited layers of the thermosetting resin to detect one or more perturbations present therein, which differ from the predefined design to form a perturbation profile;
d) adjusting the one or more deposition parameters of one or more subsequent layers based the perturbation profile; and
e) depositing the subsequent one or more layers of thermosetting resin according to the adjusted deposition parameters to form the 3D object according to the predefined design.

2. The process according to claim 1, wherein the scanner comprises an optical scanner, a laser scanner, a profile sensor, a point laser sensor, a confocal displacement sensor, an X-ray scanner, a high speed area camera, a line scan camera, or a combination thereof.

3. The process according to claim 1, wherein at least a portion of the scanning is conducted separately from the depositing of the thermosetting resin along the deposition path;
wherein at least a portion of the scanning is conducted during the depositing of the thermosetting resin along the deposition path; or a combination thereof.

4. The process according to claim 1 wherein the perturbation profile comprises:
each perturbation detected in the one or more layers of the thermosetting resin;
each perturbation detected in one or more portions of the one or more layers of the thermosetting resin;
an average of each perturbation detected in the one or more layers of the thermosetting resin;
an average of each perturbation detected in one or more portions of the one or more layers of the thermosetting resin;
or a combination thereof.

5. The process of claim 1, wherein the adjusting of one or more deposition parameters includes adjustments to the deposition path.

6. The process of claim 1, wherein the adjusting of one or more deposition parameters includes adjustments of a bead spacing at which the thermosetting resin is deposited onto a substrate or at least a portion of another layer.

7. The process of claim 1, wherein the adjusting of one or more deposition parameters includes adjustments of a tip height determined as a distance of the extrusion nozzle above the layer and/or substrate on which the thermosetting resin is deposited during at least a portion of the deposition path.

8. The process of claim 7, wherein the tip height is adjusted partially based on measured height of a deposited layer provided by the scanner to prevent accumulation of the thermosetting resin on the extrusion nozzle; to prevent contact of the extrusion nozzle with the deposited layer of thermosetting resin, or a combination thereof.

9. The process of claim 1, wherein the adjusting of one or more deposition parameters includes adjustments of an extrusion percent at which the thermosetting resin is extruded during at least a portion of the deposition path, based on a total amount of the thermosetting resin predicted to be required during the portion of the deposition path according to the predefined design.

10. The process of claim 1, wherein the adjusting of one or more deposition parameters includes adjustments of a flow rate of the thermosetting resin through the extrusion nozzle during at least portion of the deposition path.

11. The process of claim 1, wherein the adjusting of one or more deposition parameters includes adjustments of a pumping pressure applied to the thermosetting resin within the extrusion nozzle during at least portion of the deposition path.

12. The process of claim 9, wherein the pumping pressure applied to the thermosetting resin within the extrusion nozzle during at least portion of the deposition path is reduced or negative in an amount sufficient to prevent flow of the thermosetting resin through the extrusion nozzle during the portion of the deposition path.

13. The process of claim 1, wherein the adjusting of one or more deposition parameters includes adjustments of a translation speed of the extrusion nozzle along at least a portion of the deposition path.

14. The process of claim 1, wherein the adjusting of one or more deposition parameters includes adjustments of a composition of the thermosetting resin being deposited.

15. The process of claim 14, wherein the adjusting of the composition of the thermosetting resin being deposited includes adjusting a residence time and/or a temperature of the plurality of components within the mixing chamber.

16. The process of claim 14, wherein the adjustment of the composition of the thermosetting resin comprises increasing an amount of one or more of the plurality of components into the mixing chamber relative to at least one other component.

17. The process of claim 14, wherein the adjustment of the composition of the thermosetting resin comprises directing at least one additional component into the mixing chamber, and/or ceasing the directing of at least one of the components being directed into the mixing chamber.

18. The process of claim 14, wherein the adjustment of the composition of the thermosetting resin comprises directing at least a third reactive component into the mixing chamber.

19. The process of claim 14, wherein the adjustment of the composition of the thermosetting resin comprises directing one or more components into the mixing chamber effective to change a cure rate of the thermosetting resin being deposited.

20. The process of claim 14, wherein the adjustment of the composition of the thermosetting resin is effective to change a viscosity of the thermosetting resin being deposited.

21. The process of claim 20, wherein the adjustment of the composition of the thermosetting resin effective to change a viscosity of the thermosetting resin being deposited comprises:
i) beginning the directing one or more other components into the mixing chamber;
ii) increasing and/or decreasing an amount of one or more of the plurality of components being directed into the mixing chamber relative to another component;
iii) stopping the directing of one or more components into the mixing chamber;
iv) adjusting a residence time of the plurality of components within the mixing chamber; v) adjusting a temperature of the plurality of components within the mixing chamber;
or a combination thereof.

22. The process of claim 14, wherein the adjustment of the composition of the thermosetting resin is effective to change a viscoelasticity of the thermosetting resin being deposited.

23. The process of claim 1, wherein the predefined design comprises one or more necessary attributes and one or more optional attributes, and wherein the depositing of the subsequent one or more layers of thermosetting resin according to the adjusted deposition parameters forms a 3D object comprising optional attributes which differs from the predefined design, and which comprises all of the necessary attributes of the predefined design.

24. The process of claim 23, wherein the perturbation profile includes information directed to a height of the deposited layers of the thermosetting resin, and wherein the adjusting of the one or more deposition parameters of one or more subsequent layers based the perturbation profile results in a 3D object comprising at least one portion that differs in a total height from the predefined design by a distance of less than or equal to about a height of one of the deposited layers.

25. A 3D object produced according to the process of claim 1.
